(19) United States
(12) Patent Application Publication
(10) Pub. No.: US 2024/0125546 A1
(43) Pub. Date: Apr. 18, 2024

(54) APPARATUS, METHOD AND SYSTEM UTILIZING NOVEL SURFACES AND GEOMETRIES TO CRYOGENICALLY SEPARATE GASSES

(71) Applicant: AirCapture LLC, Berkeley, CA (US)

(72) Inventors: Matthew Atwood, Berkeley, CA (US); Christopher Douglas, San Francisco, CA (US); Scott Green, Berkeley, CA (US); Dakota Black, Berkeley, CA (US)

(73) Assignee: AirCapture LLC, Berkeley, CA (US)

(21) Appl. No.: 18/377,944

(22) Filed: Oct. 9, 2023

Related U.S. Application Data
(63) Continuation of application No. PCT/US23/34708, filed on Oct. 6, 2023.
(60) Provisional application No. 63/413,931, filed on Oct. 6, 2022.

(51) Int. Cl. F25J 1/02; F25J 1/00

(52) U.S. Cl. CPC F25J 1/0262; F25J 1/0027; B33Y 80/00

(57) ABSTRACT

The present invention is directed to a method, device and system to efficiently liquefy and isolate a gas from a gaseous mixture. In an embodiment of the present invention, separation of gasses from the atmosphere can be carried out using a cooled surface to separate the gasses from the atmosphere. In an alternative embodiment of the present invention, removal of CO₂ from the atmosphere can be carried out by using the method, device and system to efficiently cryogenically separate CO₂ from air and capture the CO₂ from a gaseous mixture using a surface and release the ‘CO₂ lean air’ into the atmosphere and store the captured liquefied CO₂.

### PRIORITY CLAIM

This application claims priority to (i) U.S. Provisional Application No. 63/413,931 entitled “APPARATUS, METHOD AND SYSTEM UTILIZING NOVEL SURFACES AND GEOMETRIES TO CRYOGENICALLY SEPARATE GASSES”, inventors: Atwood et al., filed Oct. 6, 2022, and (ii) Patent Cooperation Treaty Application PCT/US23/34708, entitled “APPARATUS, METHOD AND SYSTEM UTILIZING NOVEL SURFACES AND GEOMETRIES TO CRYOGENICALLY SEPARATE GASSES”, inventors: Atwood et al., filed Oct. 6, 2023, which claims the priority benefit of (i), which applications (i)-(ii) are herein expressly incorporated by reference in their entireties and for all purposes.

### FIELD OF THE INVENTION

The present invention relates to methods, compositions and devices for efficiently cryogenically separating and capturing a gas from a gaseous mixture.

### BACKGROUND OF THE INVENTION

The importance of combatting climate change is accelerating. Anthropogenic greenhouse gas emissions are the leading cause of global warming and climate change, with carbon dioxide as the primary contributor coming from both point sources and distributed emissions. The Paris Agreement 2015 highlighted the need for steep emissions cuts within the decade to keep global warming below 1.5° C. and safeguard a livable climate, as outlined in the UN Net-zero Coalition.

Cryogenic fractional distillation is commonly used to separate atmospheric air into its primary components, including nitrogen, oxygen, argon and other rare earth gases. These elements are required for semiconductor device fabrication at high purity. Alternative methods include membrane separation, pressure swing adsorption and vacuum pressure swing adsorption, and these all require cryogenic distillation. The most viable source of neon, krypton, and xenon rare gasses is cryogenic fractional distillation using at least two distillation columns. Liquefaction is also a way to purify CO₂ or other condensable gases. For example, removal of oxygen from a gaseous mixture containing CO₂ is required in many beverage and foodstuff industrial applications. In addition, sequestration of CO₂ often requires liquefying the CO₂ and removal of impurities prior to pipeline and injection.

Net emissions of carbon dioxide (CO₂) including not only requirements met by energy services, transportation, land use, agriculture, but also industrial production is a critical component in stabilizing global mean temperature. Some energy services such as heating and cooling whether household or industrial in nature may be obtained by generating electricity from renewable energy sources. However, industrial processes that necessarily utilize and release CO₂ into the atmosphere present a problem with serious consequences. To accomplish the Paris Agreement goals, heavy industrial manufacturers are quickly setting up operations with large investments, and tech companies are creating novel solutions. However, global targets are not being met. Additionally, CO₂ is a feedstock for many industrial applications and emerging technologies such as Direct Air Capture that produce gaseous CO₂ require further processing to provide CO₂ in a state (such as liquid) and purity (such as oxygen removal) for utilization. At present CO₂ is typically delivered to industrial utilization facilities via truck, which requires the loss of CO₂ along the way and increased carbon intensity of the delivery of the product associated with the production of the CO₂, logistics and losses which lead to Scope 3 emissions for industries using CO₂ for various applications.

Accordingly, in addition to post-combustion carbon capture, negative-carbon technologies can be employed in order to lower net emissions of CO₂. These negative-carbon technologies generally require a complex system of heat exchangers, condensers, gas separators, and compressors. To ensure that negative-carbon technologies do not add to the problem they are designed to address, carbon capture systems need to be extremely efficient. Furthermore, the carbon capture systems often require secondary processing to process the produced CO₂ gas into a liquid or supercritical fluid for utilization requiring further energy.

### SUMMARY OF THE INVENTION

In an embodiment of the present invention, methods, compositions and devices for efficiently cryogenically separating and capturing a gas from a gaseous mixture. In an embodiment of the present invention, the captured and separated gas is liquefied. In various embodiments of the invention, the carbon dioxide liquefied can be derived from any source. Liquefaction of CO₂ from industrial processes includes fermentation, fertilizer production and hydrogen production processes from methane such as steam methane reforming processes. In an embodiment of the present invention, liquefaction of gasses can be carried out using a cooled surface to separate the gasses. In another embodiment of the present invention, removal of a first gas from the atmosphere can be carried out using Direct Air Capture (DAC) using the method, device and system to efficiently cryogenically liquefy and separate the first gas from a gaseous mixture and capture the first gas from the gaseous mixture using a surface and either releasing the ‘the first gas lean gaseous mixture’ into the atmosphere, otherwise utilize the liquefied (solidified) first gas or store the captured liquefied (solidified) first gas. In another alternative embodiment of the present invention, removal of CO₂ from the atmosphere can be carried out using DAC using the method, device and system to efficiently cryogenically separate CO₂ from air and capture the CO₂ from a gaseous mixture using a surface and either release the ‘CO₂ clean air’ into the atmosphere, otherwise utilize the liquefied (solidified) CO₂ or store the captured liquefied (solidified) CO₂.

### BRIEF DESCRIPTION OF THE DRAWINGS

This invention is described with respect to specific embodiments thereof. Additional aspects can be appreciated from the Figures in which:

FIG. 1A is a prior art phase diagram;

FIG. 1B is a prior art enthalpy (and entropy) pressure diagram for CO₂;

FIG. 2A is a schematic diagram showing a fin with a refrigerant chamber without a wave, according to various embodiments of the invention;

FIG. 2B is a schematic diagram showing a fin with a refrigerant chamber and a wave, according to various embodiments of the invention;

FIG. 2C is a schematic diagram showing a fin with a radial width taper, according to various embodiments of the invention;

FIG. 2D is a schematic diagram showing a fin with a refrigerant chamber without a wave with fully bonded thermal contact to packing, according to various embodiments of the invention;

FIG. 3A is a schematic diagram showing a top view of a Gas Condensing Column (GCC) with an arrangement of ten (10) fins, according to various embodiments of the invention;

FIG. 3B is a schematic diagram showing a side view of a separator with channel elements to direct condensate to exterior of column, according to various embodiments of the invention;

FIG. 3C is a schematic diagram showing a side view of a separator with injection inlets at multiple points in the separator, according to various embodiments of the invention;

FIG. 4A is a schematic diagram showing a side view of three GCC modules with fins, according to various embodiments of the invention;

FIG. 4B is a schematic diagram showing a side view of three columns with gas exhaust from a first column injected into a second column, with gas exhaust from the second column injected into a third column for further purification, according to various embodiments of the invention;

FIG. 5 is a schematic diagram showing a cut away side view of a GCC module with a fin whose wave elements slant downward in a radial direction, channeling condensate outward or inward, according to various embodiments of the invention;

FIG. 6 is a schematic diagram showing a side view of a GCC module with fins and packing struts with a downward slant channeling condensate toward or away from the fins, according to various embodiments of the invention;

FIG. 7 is a schematic diagram showing a plurality of packing elements, according to various embodiments of the invention;

FIG. 8 is a schematic diagram showing a side view of a GCC module with separators 380 between the chambers 365, a cap 396 and cup 398, according to various embodiments of the invention;

FIG. 9 is an artist's line drawing showing a plurality of packing elements, according to various embodiments of the invention;

FIG. 10 is a cutaway diagram showing an arrangement of fins 220 inside a GCC device 360, with packing elements 250 between the fins, a jacket 1084 with coolant chamber 1082 and coolant flow conduits 1082, according to various embodiments of the invention;

FIG. 11A is a schematic diagram showing a top view of a GCC module with sixteen corrugated wave fins, according to an embodiment of the invention;

FIG. 11B is a schematic diagram showing a side view of a GCC module with sixteen corrugated wave fins, according to an embodiment of the invention;

FIG. 12A is a schematic diagram showing a hybrid module 361, according to an embodiment of the invention;

FIG. 12B is a schematic diagram showing a side view of a prior art or traditional module 364;

FIG. 12C is a schematic diagram showing a side view of a hybrid device 362 which includes a traditional device 359 connected to a hybrid device 361, according to an embodiment of the invention;

FIG. 13 is a schematic diagram showing a carbon dioxide liquefaction plant incorporating a chamber 365 into a column to generate a hybrid column, according to an embodiment of the invention; and

FIG. 14 is a schematic diagram showing a carbon dioxide liquefaction plant incorporating a chamber 365 into a column to generate a hybrid column, according to an embodiment of the invention.

### DETAILED DESCRIPTION OF THE INVENTION

### Definitions

The transitional term ‘comprising’ is synonymous with ‘including’, ‘containing’, or ‘characterized by’, is inclusive or open-ended and does not exclude additional, unrecited elements or method steps.

The transitional phrase ‘consisting of’ excludes any element, step, or ingredient not specified in the claim, but does not exclude additional components or steps that are unrelated to the invention such as impurities ordinarily associated with a composition.

The transitional phrase ‘consisting essentially of’ limits the scope of a claim to the specified materials or steps and those that do not materially affect the basic and novel characteristic(s) of the claimed invention. Substitution of a compound with another compound in the same group is encompassed by the phrase ‘consisting essentially of’.

The term ‘about’ means in the absence of an express range, the nominal value plus or minus a range of ten (10) percent thereof.

Carbon dioxide and CO₂ are used herein interchangeably.

A ‘metal’ comprises one or more elements consisting of lithium, beryllium, boron, carbon, nitrogen, oxygen, sodium, magnesium, aluminum, silicon, phosphorous, sulphur, potassium, calcium, scandium, titanium, vanadium, chromium, manganese, iron, cobalt, nickel, copper, zinc, gallium, germanium, arsenic, selenium, rubidium, strontium, yttrium, zirconium, niobium, molybdenum, technetium, ruthenium, rhodium, palladium, silver, cadmium, indium, tin, antimony, tellurium, cesium, barium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, thallium, lead, bismuth, polonium, francium and radium.

An ‘alloy’ is a mixture of two or more elements, where at least one element is a metal. An alloy can retain the properties of the metal, but have properties that differ from those of the pure metal. In some cases, the mixture imparts synergistic properties to the elements such as thermal conductivity. In addition, an alloy can reduce the overall cost of the material while preserving an important property.

A ‘plastic’ comprises one or more of polystyrene, high impact polystyrene, polypropylene, polycarbonate, low density polyethylene, high density polyethylene, polypropylene, acrylonitrile butadiene styrene, polyphenyl ether alloyed with high impact polystyrene, expanded polystyrene, polyphenylene ether and polystyrene impregnated with pentane, a blend of polyphenylene ether and polystyrene impregnated with pentane or polyethylene and polypropylene.

A ‘polymer’ comprises a material synthesized from one or more reagents selected from the group comprising of styrene, propylene, carbonate, ethylene, acrylonitrile, butadiene, vinyl chloride, vinyl fluoride, ethylene terephthalate, terephthalate, dimethyl terephthalate, bis-beta-terephthalate, naphthalene dicarboxylic acid, 4-hydroxybenzoic acid, 6-hydroxynaphthalene-2-carboxylic acid, mono ethylene glycol (1,2 ethanediol), cyclohexylene-dimethanol, 1,4-butanediol, 1,3-butanediol, polyester, cyclohexane dimethanol, terephthalic acid, isophthalic acid, methylamine, ethylamine, ethanolamine, dimethylamine, hexamethylamine diamine (hexane-1,6-diamine), pentamethylene diamine, methylethanolamine, trimethylamine, aziridine, piperidine, N-methylpiperidine, anhydrous formaldehyde, phenol, bisphenol A, cyclohexanone, trioxane, dioxolane, ethylene oxide, adipoyl chloride, adipic, adipic acid (hexanedioic acid), sebacic acid, glycolic acid, lactide, caprolactone, aminocaproic acid, aziridine and or a blend of two or more materials synthesized from the polymerization of these reagents.

A ‘column’ or Gas Condensing Column (GCC) device means a device used to liquefy one or more working gasses present in a mixture of gasses. GCC devices use a combination of temperature and pressure to effect cryogenic distillation. The ‘working gas’ is the gas for which the GCC device is separating from the mixture of gasses.

A ‘refrigerant’ or ‘coolant’ is a fluid used in a device to cool the device, where the refrigerant can undergo repeated heating and cooling cycles, where the refrigerant when cooled is able to reduce the temperature of a surface in the device (and as a result the refrigerant temperature is increased). The surface that is cooled can then act to reduce the temperature of gasses that contact the device.

A ‘fin’ is in ‘material contact’ with a partition wall when the fin is attached to the partition wall such that either the thermal conductivity coefficient between the fin and the partition wall is greater than 20 Wm⁻¹K⁻¹ and/or a recirculated refrigerant passing through the partition wall to the fin does not leak or otherwise escape in-between the partition wall and the fin.

A ‘contactor’ is a crucible used to hold or contain the sorbent. In an embodiment of the present invention, the crucible can be the sorbent itself. In another embodiment of the present invention, the contactor is partially transparent to radio frequency or microwaves. In an alternative embodiment of the invention, the contactor contains specific covalently bound groups to allow absorption of specific radio frequency or microwaves. In an embodiment of the present invention, the contactor is fabricated from polytetrafluoroethylene (PTFE), polymers with low dielectric constants, alumina-based ceramics, corundum, titanium-based ceramics, zeolites, fused quartz or a ferrite to minimize absorption in the resonant cavity frequency. In an embodiment of the present invention, the contactor is fabricated from a porous ceramic. In an embodiment of the present invention, the porous ceramic is a silicate, an aluminosilicate, a diatomite, carbon, corundum, silicon carbide or cordierite. In an alternative embodiment of the present invention, the contactor can be cellulose acetate. In an alternative embodiment of the present invention, the contactor can be mesoporous silica. In an alternative embodiment of the present invention, the contactor is fabricated from a glass coated ferromagnetic. In an alternative embodiment of the present invention, the contactor is fabricated from MnFe₂O. In an alternative embodiment of the present invention, the contactor is PTFE, impregnated with non-aqueous hydroxyl group containing molecules. In another alternative embodiment of the present invention, the contactor is PTFE derivatized with hydroxyl groups.

‘Additive Manufacturing’ (AM) is the automated construction of an object by adding metal to an object. In an embodiment of the invention, AM is the construction of a three-dimensional object from a model by adding a metal or an alloy to generate the three-dimensional object. AM can be done in a variety of processes in which material is deposited, joined or solidified under control with material being added to the object, typically layer by layer. In another embodiment of the invention, AM is used to build the object with a metal and a (where the metal and a generate a mixed alloy). In an alternative embodiment of the invention, AM is used to build the object with a metal and a plastic. In another alternative embodiment of the invention, AM is used to build the object with a metal and a polymer. In an embodiment of the invention, AM is used to build the object with a metal and a ceramic. Appendix A (attached herein) discloses features and limitations of the use of AM to build GCC devices as envisioned in various embodiments of the invention and is herein expressly incorporated by reference in its entirety and for all purposes.

In an embodiment of the present invention, AM enables optimization of the design of a GCC device. The GCC device design includes chambers. A chamber can be added to other chambers, so as to build a hierarchy or architecture of the GCC device. The design freedom allows small scale manufacturing (i.e., gas condensing surfaces and therefore liquefaction equipment scale is matched to the requirements of the gas system and the technical/scientific/industrial challenge). The details of DAC are disclosed in U.S. national stage Application No. 17787262 filed Jun. 17, 2022, entitled “APPARATUS, METHOD AND SYSTEM FOR DIRECT AIR CAPTURE UTILIZING ELECTROMAGNETIC EXCITATION RADIATION DESORPTION OF SOLID AMINE SORBENTS TO RELEASE CARBON DIOXIDE”, inventor: Matthew Atwood, which application is herein expressly incorporated by reference in its entirety and for all purposes. The effect of contact between system components increases thermal conductivity by using AM to ensure physical contact of the surfaces which increases material flow, thermal conductivity and increases effectiveness of separation.

Use of AM results in improved thermal recovery/heat integration and thereby an increased exergy design. The use of AM also allows configuration/building/manufacturing of the GCC device with surface complexities that enable lower overall material utilization, higher heat transfer rates and more efficient gas condensation and gas/liquid separation that is not possible with other manufacturing techniques. In an embodiment of the present invention, the refrigerant is cooled via a chiller or a heat pump. In an embodiment of the present invention, the process heat is recovered and used to provide process heat for another process that produces the gas, e.g., CO₂ in a DAC. It is also possible to liquefy carbon dioxide at ambient temperatures if the temperature is increased significantly. This is typically done with a heat exchanger positioned after the compressor to bring the carbon dioxide back to ambient temperature. It is also possible to liquefy carbon dioxide at ambient temperatures if the pressure is increased significantly.

A ‘refrigerant loop’ can be a single flow loop, closed coolant system. In an embodiment of the present invention, the refrigerant is flowed through the jacket of the column which is fluidically connected to the internal volume of the fins. In an embodiment of the present invention, one refrigerant can be used in the jacket of the column and a second refrigerant can be used in the fins.

In an embodiment of the present invention, by undertaking AM of the chamber with a refrigerant volume (jacket) and fins containing refrigerant a comparison of different refrigerants can be efficiently undertaken. Fin design maintains constant T in x, y with variable temperature or heat transfer in z axis. Fins can be variable width to enable uniform refrigerant/heat transfer in x axis, y axis, as well as z axis. Vertical wave in Fins enables control of refrigerant flow rate and distribution. The amplitude of fin wave can vary in the z axis, to enable modulation of the refrigerant temperature as well as the separation of liquid product from condensed gasses (e.g., CO₂ from air). The number of fins can vary depending on heat exchange (cooling) needs at different stages of the column. Surface finish of fins (in and out) can be controlled with AM to enable increased efficiency of separations/thermal exchange.

The phrase ‘packing material’ or ‘packing elements’ means a component that provides a condensation surface on which the condensable gas can cool. In an embodiment of the invention, the packing material is generated by AM. An increase in Surface area to volume (SaV) results in an increase in effective condensation due to Surface Area (SA) and thermal transfer. Non-periodic nature of packing avoids liquid plus gas flow bottlenecks during operation. The ability to vary density of packing in z axis allows tuning of condensation rate to liquid/gas fraction which varies in the z axis. High connectivity of the packing enables liquid to accumulate and flow down with gravity. Radial tilt in fin channels produces path for condensate to flow towards edges of chamber. Superposition of periodic stints in packing channels condensate to the fins to increase effective separation and decrease entrainment of gas molecules in condensed liquid, thereby increasing the purity of the liquefied product. Periodic high torsion packing surfaces such as gyroidal and helical local structures allow simultaneously increased SaV and turbulent fluid flow and pathways for liquid and gas separation, towards better falling film development. Variable packing density in x, y (radial position) and distance to fin enables channeling of gas plus fluid flow and control of heat transfer/condensation rate. A ‘packing material’ is in ‘physical contact’ with a fin when the thermal conductivity coefficient between the packing material and the fin is greater than 20 Wm⁻¹K⁻¹. Without being bound by any theory, it is believed that packing elements result in an increase in the overall thermal conductivity between a gas stream and the fins due to the significant surface area of the packing elements.

A ‘traditional chamber’ is a device to condense gases comprising two fluid volumes that share common surfaces. A ‘traditional chamber’ does not comprise a packing material. The first fluid volume is configured to contain a cryogenic fluid or refrigerant with an inlet and an outlet. The second fluid volume is configured to have an inlet on the bottom into which at least two gases enter and a multitude of tubes that transmit the gases towards the outlet. A hermetic seal exists between the first and second fluid volumes that can withstand the pressure differentials between the first and second fluid volumes, and the fluid volumes and the external atmosphere. The condensed gas collects on the walls of the tubes and is directed downwards with gravity whereas the non-condensed gases will exit the second fluid volume at the outlet.

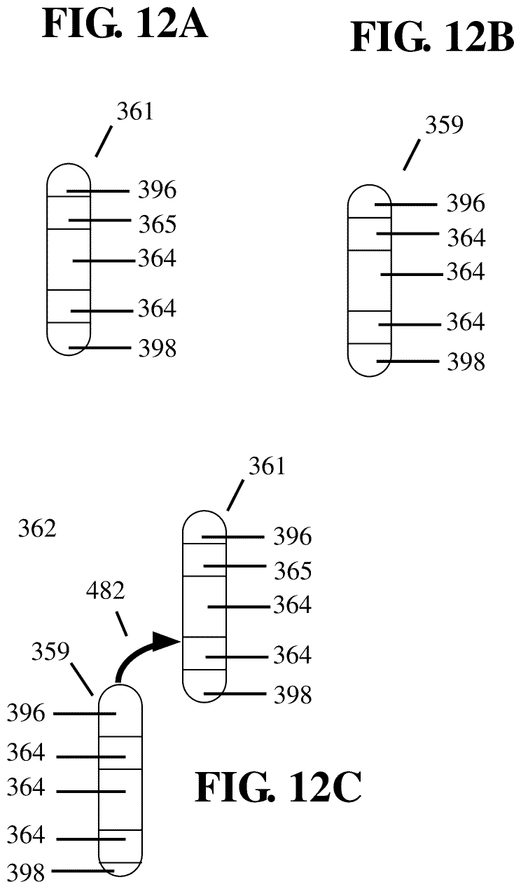

In an unexpected and striking effect, the time for liquid carbon dioxide to accumulate from a first predefined level (sensor) to a second predefined level (sensor) decreased to forty (40) minutes for the arrangement shown in FIG. 12A from three (3) hours for the arrangement shown in FIG. 12B (i.e., a system 361 with one chamber 365 connected to traditional chambers 364 compared to a non-additively-manufactured device 359 with only traditional chambers 364). In an unexpected technical effect, the time for liquid carbon dioxide to accumulate from a first predefined level (sensor) to a second predefined level (sensor) decreased to forty (40) minutes for the arrangement shown in FIG. 12A from three (3) hours for the arrangement shown in FIG. 12B. In an unconventional or unexpected result, the time for liquid carbon dioxide to accumulate from a first predefined level (sensor) to a second predefined level (sensor) decreased to forty (40) minutes for the arrangement shown in FIG. 12A from three (3) hours for the arrangement shown in FIG. 12B. In a remarkable effect, the time for liquid carbon dioxide to accumulate from a first predefined level (sensor) to a second predefined level (sensor) decreased to forty (40) minutes for the arrangement shown in FIG. 12A from three (3) hours for the arrangement shown in FIG. 12B. In a bonus effect, the time for liquid carbon dioxide to accumulate from a first predefined level (sensor) to a second predefined level (sensor) decreased to forty (40) minutes for the arrangement shown in FIG. 12A from three (3) hours for the arrangement shown in FIG. 12B. In an unexpected and striking effect, the level rate of increase of liquid carbon dioxide in the distillation column for the arrangement shown in FIG. 12A increased by 92 percent compared to the arrangement shown in FIG. 12B. In an unexpected technical effect, the level rate of increase of liquid carbon dioxide in the distillation column for the arrangement shown in FIG. 12A increased by 92 percent compared to the arrangement shown in FIG. 12B. In a remarkable effect, the level rate of increase of liquid carbon dioxide in the distillation column for the arrangement shown in FIG. 12A increased by 92 percent compared to the arrangement shown in FIG. 12B. In a bonus effect, the level rate of increase of liquid carbon dioxide in the distillation column for the arrangement shown in FIG. 12A increased by 92 percent compared to the arrangement shown in FIG. 12B. In an unexpected and striking effect, the arrangement shown in FIG. 12A produced liquid CO₂ with less O₂ compared to the arrangement shown in FIG. 12B. In an unexpected technical effect, the arrangement shown in FIG. 12A produced liquid CO₂ with less O₂ compared to the arrangement shown in FIG. 12B. In an unconventional or unexpected result, the arrangement shown in FIG. 12A produced liquid CO₂ with less O₂ compared to the arrangement shown in FIG. 12B. In a remarkable effect, the arrangement shown in FIG. 12A produced liquid CO₂ with less O₂ compared to the arrangement shown in FIG. 12B. In an unexpected remarkable effect, the arrangement shown in FIG. 12A produced liquid CO₂ with less O₂ compared to the arrangement shown in FIG. 12B.

Gaps in separators allow channeling of fluids and injection of gasses in different locations. In an embodiment of the present invention, geometries can be included in the column gap separators that enable channeling of the condensed fluid in a direction such as towards the walls of the condenser, or towards the middle of the condenser.

‘Carbon capture’ is a physical and/or chemical process which involves fluid and gas combined at a temperature, and a pressure. A critical component of carbon capture used in air capture is ‘catching’ the carbon with a structured mechanical filter. In post combustion capture, liquid amines are used without a structured filter. Air is drawn into the system through the first (i.e., direct air contact) stage. Direct air contact filter efficiency can be optimized by filter structures that allow for maximum contact between incoming air and the filter surface. Efficiency in carbon capture is a function of yield over energy input. In an embodiment of the invention, AM can be used to generate the design of filters which do not induce high levels of turbulence and mixing. In an embodiment of the invention, AM can also be used to generate a filter with a high surface area for maximum air contact. By increasing the surface area of the filter, the yield can also be increased without a significant increase in energy input.

A ‘chiller’ and/or a ‘distiller’ include refinement columns that can comprise distillers with integrated chilling. In an embodiment of the invention, the carbon-rich product which exits the filter stage can be considered ‘dirty’ and in need of further refinement to be usable. In an embodiment of the invention, this dirty carbon post-processing can be accomplished using chillers and/or distillers. In an embodiment of the invention, the chillers and/or distillers outside of a self-contained system. However, chillers and/or distillers positioned separate or outside of a self-contained system generally result in more carbon produced. The most valuable and promising carbon capture systems have some level of integrated dirty carbon product post-processing using chillers and distillers such that the output of a carbon capture system consists of clean usable carbon product. The by-product of the liquefaction is generally a mixture of air and CO₂, where the CO₂ can be as much as forty (40) percent of the total CO₂ liquefied, which goes out the top of the column. Generally, water is removed prior to liquefying CO₂, as liquefying CO₂ with water forms clathrates.

A ‘sorbent’ is a material that is capable of forming a physical or chemical bond with CO₂ molecules present in air. The CO₂ molecules in a feed material that is to be processed are absorbed or adsorbed by the sorbent. In an embodiment of the invention, the feed material is atmosphere. In an embodiment of the present invention, the sorbent is a poly amine sorbent. In an embodiment of the present invention, the sorbent is a plastic impregnated with an amine. In an embodiment of the present invention, the sorbent is selected from the group consisting of linear PEI, branched PEI, linear PEI functionalized cellulose acetate silica dioxide, branched PEI functionalized cellulose acetate silica dioxide, PAA poly(allylamine) and PPI poly(propyleneimine).

The ‘aspect ratio’ of a process chamber is the ratio of its width to its height, e.g., x:z, x units wide and z units high.

For the purposes of clarifying orientation the word ‘above’ when used in relation to the positioning of e.g., the first inlet and the first outlet when the GCC device is in use, means that a liquid would flow under gravity from e.g., the first refrigerant inlet to the first refrigerant outlet or the second refrigerant inlet to the second refrigerant outlet and so forth. The word ‘above’ when used in relation to the positioning of e.g., the first chamber and the second chamber means that a liquid would flow under gravity from the first chamber to the second chamber or the second chamber to the third chamber and so forth. This clarification does not require a gravitational liquid flow from e.g., the first refrigerant inlet to the first refrigerant outlet, i.e., the liquid flow from e.g., the first refrigerant inlet to the first refrigerant can be under pressure. Further, this clarification does not require a liquid flow from e.g., the first chamber to the second chamber, i.e., a gas in the first chamber can flow to the second chamber through the first working outlet and the second working port OR a gas can condense in the first chamber and can flow to the second chamber through the first working outlet and the second working port.

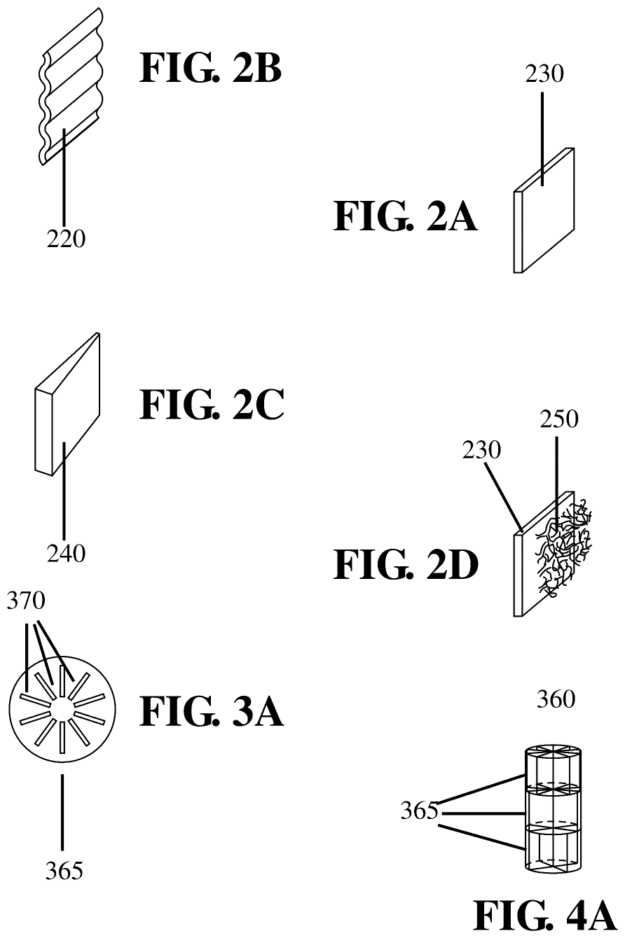

The term ‘corrugated’, ‘corrugated wave’ or ‘corrugated transverse wave’, means a series of approximately parallel crests and troughs as shown in FIG. 2B, where the amplitude of the wave is the distance from the center point of the transverse wave to the crest or trough. In this range approximately means plus or minus ten (10) degrees.

The phrase ‘surface roughness’ or ‘roughness’ means the surface finish or surface texture and is determined by the change (δ) of the normal vector compared to an ideal surface (δ=0). If δ is large, the surface is rough; if δ is small, the surface is smooth. The profile roughness parameter is given by the ISO 4287:1997 standard, where grade N1 corresponds with 0.025 micros and N12 corresponds with 50 microns.

A ‘hollow periodic fin radial array’ is shown in FIG. 2B. The hollow periodic fin radial array enables highly efficient cooling due to its geometry and offers room for structured packing for condensate. In Appendix A, FIG. 7 shows transient analysis of the cooling performance of spiral line and a hollow periodic fin radial array. The hollow periodic fin radial array satisfies the intended requirement of extremely low or no cooling gradient across the XY plane, as well as a significant magnitude of cooling, providing a chilling effect. There are several key aspects to the design of the periodic fin array, including a ‘constant cooling volume’, a ‘hollow core’, and a ‘periodic fin’. When taking any lateral cross-section up and down the Z axis, the same total cooling volume can be obtained. This ensures that no matter what the cooling capacity of the GCC device, even planar cooling capacity will be obtained. This is less of an intentional design feature, but rather a manufacturability and functional compromise which provides acceptable behavior. Theoretically it can be desirable for the cooling fins to converge in the center with no dimension (i.e., infinitely thin). In an embodiment of the invention, the fins have a finite thickness at the center or may not extend all the way to the center. This compromise is acceptable because the radiative cooling effect of the axial faces of the fin directs cooling towards the center and provides even and constant cooling in the axial core. A non-periodic (i.e., flat without a wave) hollow fin can provide a very direct path to ground due to gravity. This is not advantageous as increasing the residence time to loiter and mix in the fins provides significant cooling. A periodic fin also provides radiative cooling in many vectors, spreading the volumetric cooling potential for any cooling surface area unit over a greater space. When combining many periodic fins in a radial array, the volumetric cooling potential zones are overlapping. Periodic fins also provide a more tortuous open area for condensing lattice. In this case, the gas passing through the inter fin lattice spends more time in pockets thereby encouraging condensate to form.

‘Deployed’ means attached, affixed, adhered, inserted, or otherwise associated. A reservoir is a vessel used to contain one or more of a liquid, a gaseous or a solid sample.

The term ‘spacer’ means a module in a GCC device without any channel elements 392. The phrase ‘spacer/separator’ means a module in a GCC device which itself is not the primary locus of active condensation.

The phrases ‘gas lean’ or a ‘stream of gas lean gaseous mixture’ means a gas in which a specific chemical's abundance has been reduced. For example, a gas lean carbon dioxide is a gas in which carbon dioxide molecules have been removed.

In the following description, various aspects of the present invention will be described. However, it will be apparent to those skilled in the art that the present invention may be practiced with only some or all aspects of the present invention. For purposes of explanation, specific numbers, materials, and configurations are set forth in order to provide a thorough understanding of the present invention. However, it will be apparent to one skilled in the art that the present invention may be practiced without the specific details. In other instances, well-known features are omitted or simplified in order not to obscure the present invention.

DAC involves the separation of a first gas from a gaseous mixture. For example, DAC can involve the separation of CO₂ from air. DAC is regarded as an attractive and scalable carbon mitigation pathway strategy if CO₂ is geologically sequestered or up-converted into materials such as concrete, fuels, polymers and carbon fibers. DAC has the potential to achieve net negative emissions at the multi GT/y scale by the year 2050. However, the technologies, costs and process steps involved with DAC can limit its application to large-scale embodiments that are not well-suited for market adoption requiring compression, liquefaction, storage and transportation of the CO₂ to the commercial customer. DAC also enables sequestration, the ability to store CO₂ for constructive purposes, turning it from a threat to an opportunity. On-site production and sequestering of CO₂ from DAC to existing agricultural product, building material, fuels, plastic, and chemical industries that use CO₂ can decrease the costs of CO₂ to the customers and provide a more sustainable supply while meeting emission reduction targets/requirements. However, DAC alone does not generally produce a CO₂ product usable by industry. Typically, CO₂ needs to be compressed and/or liquefied to remove contaminants in order for the CO₂ to be utilized.

In an embodiment of the invention, a GCC separates the CO₂ molecules from the air under specific pressure and temperature conditions, by liquefying and collecting the CO₂ molecules and releasing gaseous depleted CO₂ air. By doing so, the process avoids the capital and energy costs involved with the desorption of the CO₂ and by generating liquid CO₂ lends the product to the storage and/or transportation of the CO₂ generated.

CO₂ is useful to industry and DAC enables utilization of lower-cost and more sustainable supplies of CO₂ to existing and future markets. Additionally, CO₂ supplied from DAC can replace existing CO₂ sources used in industry that ultimately increase atmospheric CO₂ loading. DAC can be used meet emission reduction requirements of industry.

The first order considerations when designing GCC systems are i) the energy cost of contacting CO₂ with the GCC device under appropriate pressure and temperature conditions, and ii) capital and maintenance costs of the system. When making liquid CO₂, this is also a major energy cost, and reducing the energy cost of CO₂ liquefaction is required. In the embodiment of the invention, AM enables decreasing costs of liquefying CO₂ through higher efficiency and lower capital cost equipment. Further, it enables more efficient thermal recovery through integration of a heat pump required to generate the chilling loads required, which heat can be recovered from and used to provide the thermal input for DAC or another industrial process.

In an embodiment of the present invention, a GCC device takes warm/hot steam full of carbon product (CO₂) as input, and produces refined, concentrated carbon product (CO₂). In an alternative embodiment of the present invention, a GCC device takes carbon product (CO₂) that has been heated by exposure to microwaves or other sources of energy as input, and produces refined, concentrated carbon product (CO₂). In an embodiment of the current invention, a GCC device takes CO₂ that has been produced through another industrial process and produces refined, concentrated carbon product (CO₂). In an embodiment of the present invention, the input gas can be chilled to create a condensate and a GCC device used to provide ample surface area for condensate to collect and create precipitate. Additionally, it's desirable to have monolithic parts that require little or no assembly. The process chamber provides an airtight structure to contain the components of a chemical process or reaction. There can be thermal, pressure, flow, and instrumentation requirements applied to a single monolithic process unit.

In an embodiment of the present invention, a ‘process chamber’ can be pill-shaped cylinder. The dimensions and aspect ratio of a cylindrical process chamber are as defined in equation 1.

SaV>2×D Equation 1,

where SaV is the aspect ratio and D is the diameter of the cylindrical process chamber.

In an embodiment of the invention, a collection ‘cup’ or ‘bowl’ with a port can be located on the bottom of the GCC device.

In an embodiment of the invention, ‘cap’ or ‘dome’ with a port can be located on the top of the GCC device to allow uncondensed gasses to exit.

The injection port can be located in the bottom of the column, at the top of the column, or in the middle portion of the column in order to channel the direction of the condensed gas. Channeling enables more efficient condensation and reduced inclusion of impurities from non-condensed gases into the condensed gas liquid.

A temperature sensor can be used to control process equipment such as the temperature or flow rate of the refrigerant and/or the temperature of the process gas. Alternatively, a pressure sensor can be used to control process equipment flow rate of the refrigerant and/or the pressure of the process gas.

In an embodiment of the invention, a refrigerant system includes a heat pump. In an embodiment of the invention, heat generated by the heat pump can be recovered. In an embodiment of the invention, exhaust gas can be reinjected back into a GCC device (or another GCC device or a DAC device) for further separation.

Chambers can be jacketed with refrigerant/insulated/vacuum jacket. In an embodiment of the present invention, a GCC device can be made up of chambers that are jacketed with a refrigerant.

The actively cooled portion of the process chamber has a relatively high diameter:height ratio. Due to the high aspect ratio for the specific efficiency targets, the chiller modules can be designed to be AM at nearly the full height of the AM printer, then combined in a stack. With current commercially available 3D printers the dimension is approximately 400 mm. However, this may become larger and wider in the future enabling larger embodiments. However, for smaller scale non-industrial, more commercial systems it is possible to AM a complete chamber in one piece, with one build. In addition, chambers can be modular where more than one chamber can be combined serially. For industrial, high-output stacks, using a modular approach affords advantages, allowing changes to the parameters of the module. For example, different modules can have different packing and cooling densities per module (if required). Process modules are then joined with a simple spacer flange, which also allows for instrumentation and introduction ports 390 at various heights.

In an embodiment of the present invention, a chiller can provide temperature control to rapidly cool hot gas. This chiller can also be a part of a heat pump, heat from which can be used for an additional process in the overall system design, such as some or all of the heat required for DAC.

In an embodiment of the present invention, a structured packing can provide a high surface area that will thermally couple to the chilling mechanism as a super structured packing (SSP). In an embodiment of the present invention, a SSP can provide an increased surface area for condensate to form. The dimensions of the SA or open space in the packing density can be given by equation 1. The dimensions of the SA to open space in the packing density is described as Appendix A.

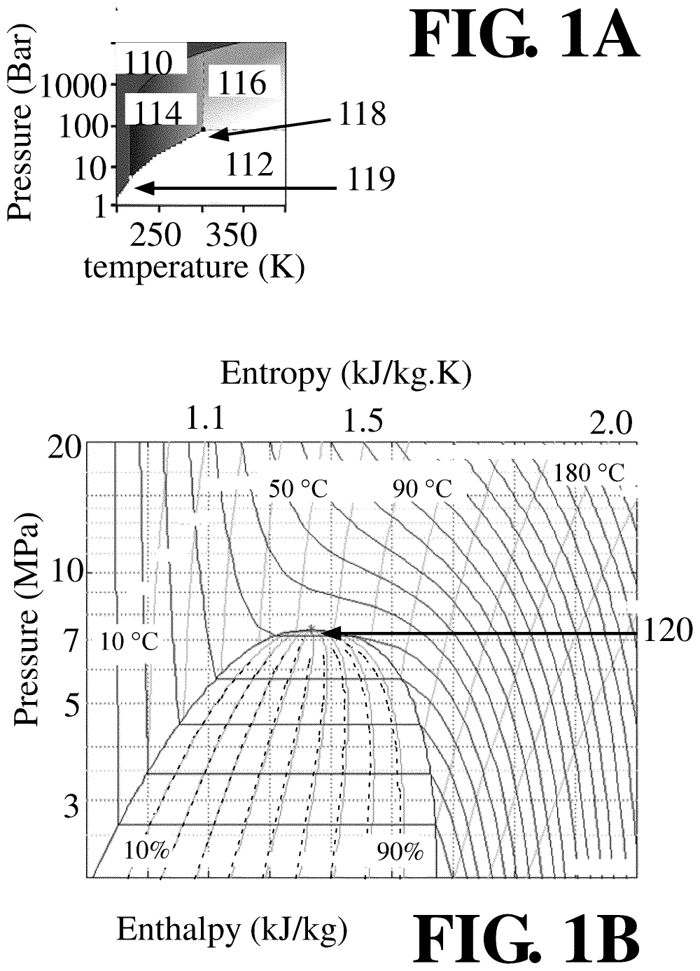

The binary separation process between air (which is made up of 70% nitrogen) and CO₂ can be approximated for phase diagrams of different CO₂—N₂ gas mixtures. A general phase diagram is shown in FIG. 1A, where 110 shows the solid phase boundary, 114 shows the liquid phase boundary, 116 shows the supercritical fluid phase boundary, 112 shows the gas phase boundary, 118 shows the critical point, and 119 shows the triple point at which gas, liquid, and solid phases can coexist. FIG. 1B a P-h diagram for CO₂ where 120 shows the critical point pressure 72.8 MPa at 31° C.

In an embodiment of the present invention, the poly amine sorbent can be linear polyethylenimine (PEI), branched PEI, aziridine, diethylenetriamine, triethylenetetramine, diethylenetriamine organosilane, and aminopropyl organosilane. In an alternative embodiment of the present invention, the poly amine sorbent can be linear PEI functionalized cellulose acetate silica dioxide sorbent, branched PEI functionalized cellulose acetate silica dioxide sorbent material, linear PEI incorporated into a metal organic framework, branched PEI incorporated into a metal organic framework, and amine incorporated into a metal organic framework. In another alternative embodiment of the present invention, the poly amine sorbent can be a mesoporous material selected from the group consisting of M41S, FSM-16 and SBA-15 modified with amino groups such as polyethylene MCM-41, or 3-trimethoxysilylpropyl diethylenetriamine SBA-15. In an alternative embodiment of the present invention, alternative higher adsorption capacity sorbents and alternative contactor materials can be used with MWSD. For example, some amine-silica sorbent materials which are known to degrade to some extent in the presence of steam may be useful with the present invention where desorption is under sufficiently anhydrous conditions.

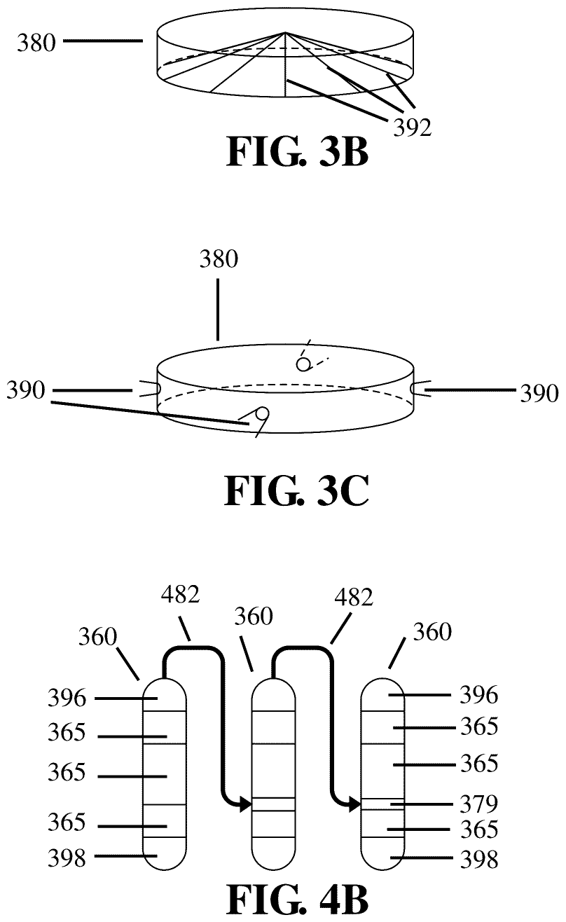

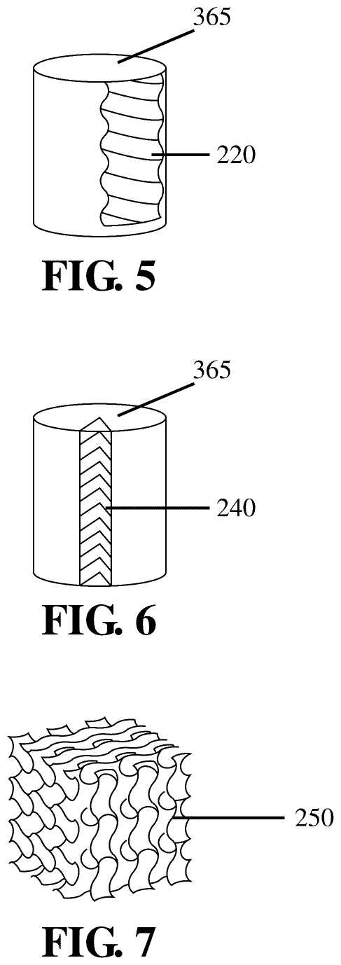

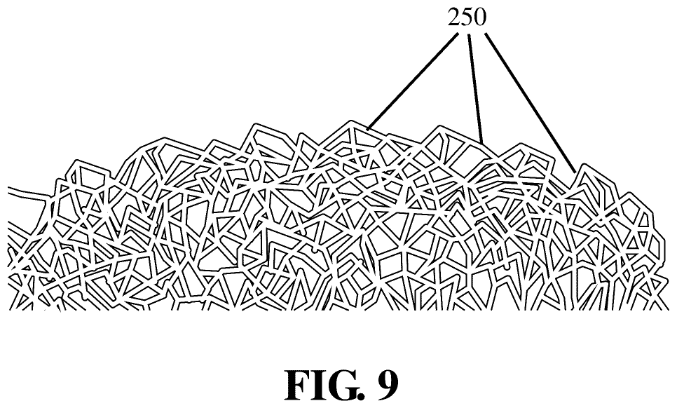

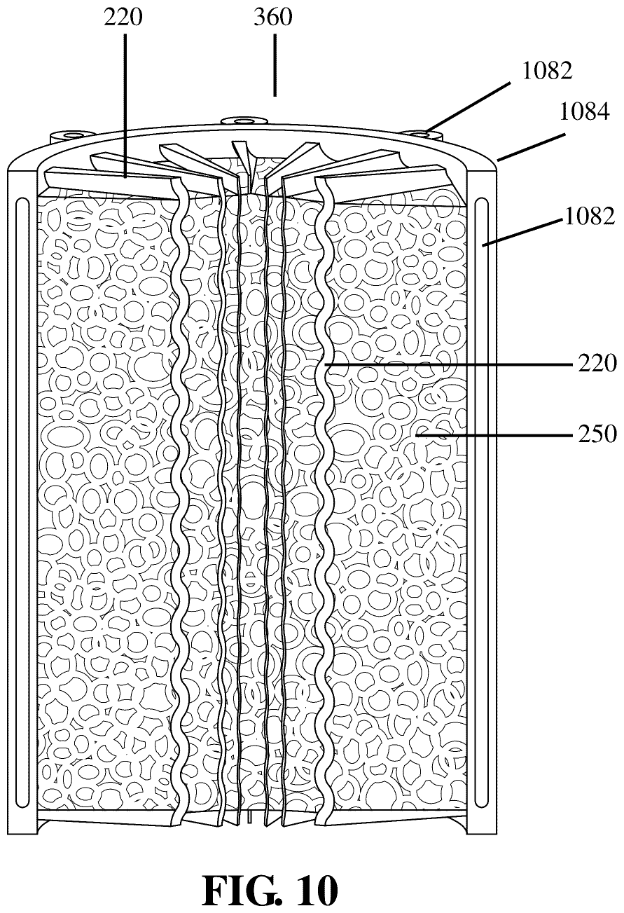

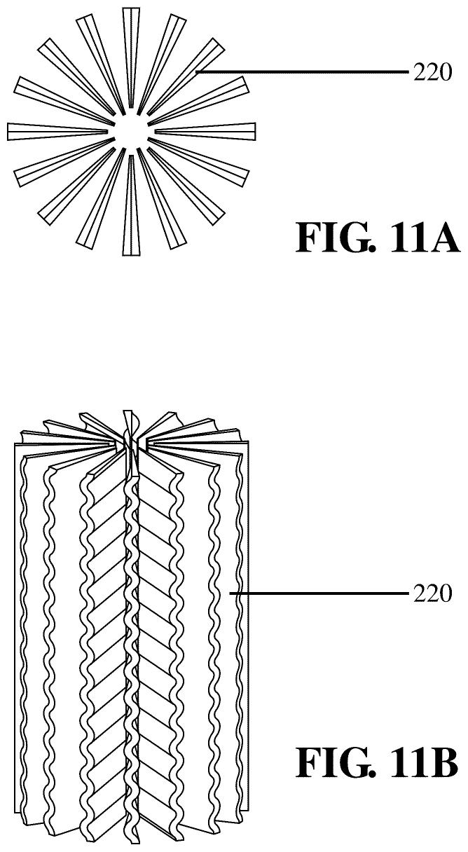

In various embodiments of the present invention shown in FIGS. 2A, 2B, 2C a fin 220, 230 and 240 containing a refrigerant chamber can be cuboid (i.e., flat) 230, periodic (i.e., corrugated with a wave) 220 (oriented towards the center of a chamber 365 as shown in FIGS. 5 and 11) and tapered 240 (thickness reducing to a point oriented towards the center of a chamber 365 (as shown in FIG. 11) 240. FIG. 11A is a schematic diagram showing a top view of a GCC module with sixteen corrugated wave fins. FIG. 11B is a schematic diagram showing a side view of a GCC module with sixteen corrugated wave fins. In an embodiment of the present invention, packing elements and/or a plurality of packing elements 250 (shown in FIGS. 7, 9 and 10) can be attached to a fin and/or a plurality of fins as shown for the cuboid fin 230 in FIG. 2D. The plurality of packing elements or a packing element is formed as a structured strut lattice with perturbed periodic node placement. In an embodiment of the present invention, a fin 230 and/or a plurality of fins 370 are present in a chamber 365 as shown in FIG. 3A. In an embodiment of the present invention, a plurality of fins 370 are present in a plurality of chambers 365 that make up a GCC device 360 as shown in FIG. 4A. In an embodiment of the present invention, a chamber 365 can be located adjacent to one or more traditional chambers 364 (not shown). In an embodiment of the present invention, a spacer 379 (without any channel elements 392) can be located between chambers 365 as shown in FIG. 4B. In an embodiment of the present invention, a spacer 379 can be located between a chamber 365 and traditional chambers 364 (not shown).

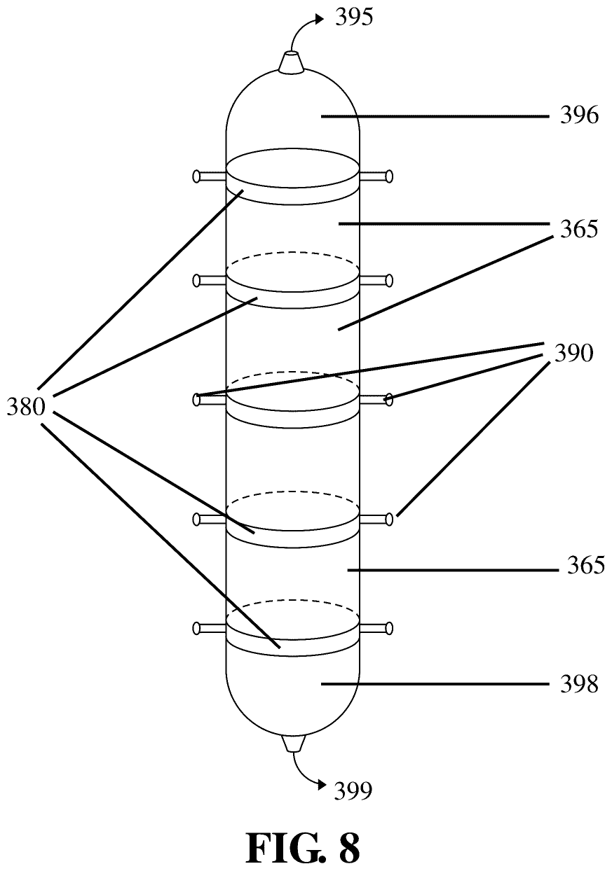

In an embodiment of the present invention, a plurality of channel elements 392 are present in a spacer/separator 380 which can be between chambers 365 as shown in FIG. 3B. In another embodiment of the present invention, a plurality of channel elements 392 are present in a spacer/separator 380 which can be between a chamber 365 and traditional chambers 364 (not shown). In an alternative embodiment of the present invention, a plurality of channel elements 392 are present in a spacer/separator 380 which can be between traditional chambers 364 (not shown). In an embodiment of the present invention, a plurality of introduction ports 390 are present in a spacer/separator 380 which can be located between chambers 365 as shown in FIG. 3C. In an embodiment of the present invention, the working port/outlet 482 can be deployed to a spacer/separator 380 (not shown). In another embodiment of the present invention, the working port/outlet 482 can be deployed to a cap 396 (not shown). In an alternative embodiment of the present invention, the working port/outlet 482 can be deployed to a cup 398 (not shown). In an embodiment of the present invention, the cap 396 can be connected to a spacer/separator 380 with one or more introduction ports 390 located between one or more chambers 365 that make up a GCC device 360 as shown in FIG. 8. In an embodiment of the present invention, one or more of a plurality of spacer/separators 380, a plurality of chambers 365, a cap 396, and a cup 398 with exit ports 395 and 399 respectively, can be present in a GCC device 360 in which the spacer/separators 380 can be located between chambers 365 as shown in FIG. 8. In an embodiment of the present invention, the cap 396 can be connected to a spacer with one or more introduction ports 390 located between one or more chambers 365 that make up a GCC device 360 (not shown). In an embodiment of the present invention, one or more of a plurality of spacers, a plurality of chambers 365, a cap 396, and a cup 398 with exit ports 395 and 399 respectively, can be present in a GCC device 360 in which the spacers can be located between chambers 365 (not shown). In an embodiment of the present invention, the exit ports 395 and 399 can be used to remove the gasses separated cryogenically. In various embodiments a spacer/separator 380 can include one or more channel elements 392. In various embodiments a spacer/separator 380 can include one or more introduction ports 390. In various embodiments a spacer 380 can include one or more introduction ports 390. In an embodiment of the invention, a GCC device with two or more chambers 365 can include a spacer/separator 380. In another embodiment of the invention, a GCC device with two or more chambers 365 can include a spacer.

Various embodiments of the present invention include hybrid condensation devices 361, 362. FIG. 12A is a schematic diagram showing a hybrid module 361. FIG. 12B is a schematic diagram showing a side view of a traditional device 359. A comparison showing in a particular embodiment the time for liquid carbon dioxide to accumulate from a predefined level (sensor) to a higher predefined level (transmitter) for the arrangement shown in FIG. 12A compared with the arrangement shown in FIG. 12B is given in Table 1. Table 1 also compares the rate of increase liquid carbon dioxide in the column, the liquid CO₂ production rate (where 0.226 kg=1 inch=25.4 mm), and the amount of O₂ in the liquid CO₂ that was generated. In Table 1, conditions such as column pressure, and coolant temperature were kept as close as possible when comparing the two arrangements. It was noted that the compressor was stopping frequently with the arrangement shown in FIG. 12B to avoid over pressurizing the column. With the arrangement shown in FIG. 12A the compressor was able to run continuously. Without being bound to any particular theory or explanation, this can be due to the more rapid condensation in the column with the arrangement shown in FIG. 12A. With the arrangement shown in FIG. 12A a similar rate of venting was used as the arrangement shown in FIG. 12B, but the production in the arrangement shown in FIG. 12A was found to be much higher (specifically, 92 percent higher) than the arrangement shown in FIG. 12B. FIG. 12C is a schematic diagram showing a side view of a hybrid device 362 which includes a traditional device 359 connected to a hybrid device 361. In an embodiment of the present invention, a hybrid condensation device 361 can be generated by attaching a cap 396 with one or more chambers 365, onto one or more traditional chambers 364 connected to a cup 398 as shown in FIG. 12A. In another embodiment of the present invention, a hybrid condensation device 362 can include a traditional condensation device 359 in liquid communication 482 with a hybrid condensation device 361, where the traditional condensation device 359 includes a cap 396, a plurality of traditional chambers 364, and a cup 398, where the hybrid condensation device 361 includes a cap 396, one or more chambers 365, one or more traditional chambers 364, and a cup 398 as shown in FIG. 12C. In an alternative embodiment of the present invention, a hybrid condensation device 362 can include a traditional condensation device 359 in liquid communication 482 with a GCC 360, where the traditional condensation device 359 includes a cap 396, a plurality of traditional chambers 364, and a cup 398, where the GCC 360 includes a cap 396, one or more chambers 365, and a cup 398 (not shown).

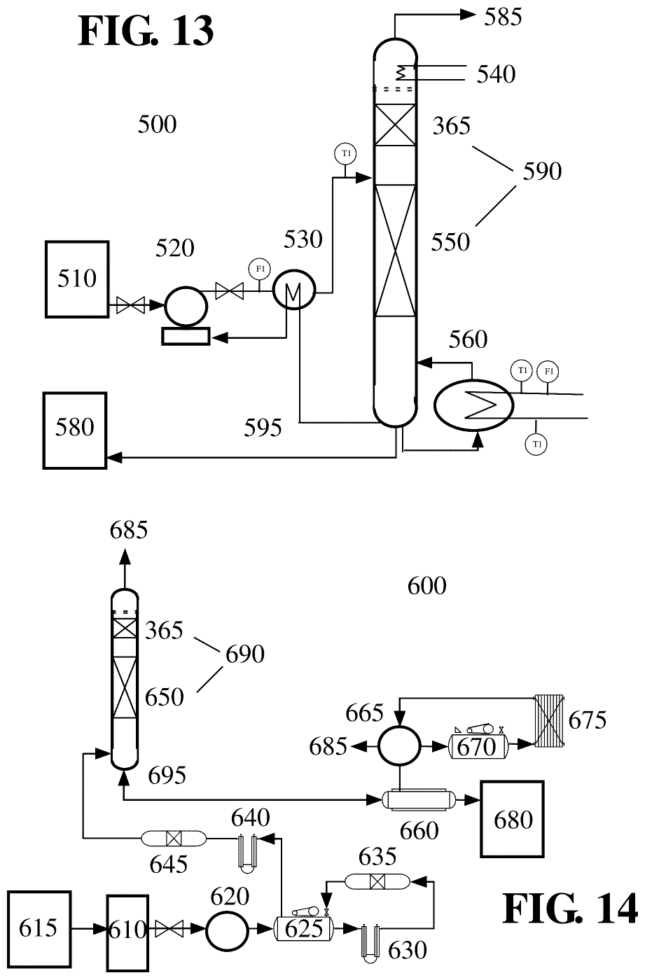

FIG. 13 is a schematic diagram showing a carbon dioxide liquefaction plant 500. The carbon dioxide feed reservoir 510 directs the carbon dioxide into a washing tower 520 and then into a heat exchanger 530 and finally into a regeneration column 550. In an embodiment of the invention, the regeneration column 550 is a GCC device incorporating a chamber 365 to generate a hybrid regeneration column 590. A reboiler 560 is used to purify the carbon dioxide in the regeneration column 590. The outflow 595 from the regeneration column 590 is collected in a liquid storage tank 580.

FIG. 14 is a schematic diagram showing an alternative carbon dioxide liquefaction plant 600. The carbon dioxide source 610 and or a carbon dioxide gas storage balloon 600 are fed into a washing tower 620 and then into a compressor 625 and from there into a first separator 635 via an intercooler 630. The flow from the first separator 635 is directed back into the compressor 625 and then into a second separator 650 via an aftercooler 640. In an embodiment of the invention, the second separator 650 includes a GCC device incorporating a chamber 365 to generate a hybrid separator 690. The carbon dioxide outflow 695 from the hybrid separator 690 is transferred to a dryer 645 and then to a reboiler 660. The reboiler 660 uses a refrigerating compressor 670, a condenser 675, and a liquefier 665 to further liquefy the carbon dioxide. The liquid from the reboiler is ultimately fed to a carbon dioxide liquid storage tank 680.

### OTHER EMBODIMENTS

Embodiments contemplated herein include Embodiments P1-P53 and Q1-Q49 following.

Embodiment P1. A GCC device with height H for cryogenically separating a first gas from a gaseous mixture including a first chamber comprising a diameter (D), a first volume, and a second volume (V₂), where a first partition wall at least partially separates the first volume from V₂, where the first volume is in fluid contact with a first refrigerant inlet and a first refrigerant outlet, where V₂ comprises a first working port and a first working outlet, a plurality of fins comprising a width (W) are located in V₂, where at least one of the plurality of fins is in physical contact with the first partition wall, where at least one of the plurality of fins comprises a first passage, a first passage entrance and a first passage exit, where the first passage connects the first passage entrance to the first passage exit, where the first passage entrance and the first passage exit traverse the first partition wall such that the first passage is in liquid contact with the first volume, a refrigerant supply, where the refrigerant supply is adapted to connect with the first refrigerant inlet and the first refrigerant outlet to allow a cryogenic refrigerant to enter the first volume at a first temperature (T₁), where the refrigerant supply is adapted to flow from the first volume into the first passage entrance and exit the first passage through the first passage exit, where the cryogenic refrigerant is in liquid contact with at least with the first volume, where the cryogenic refrigerant is in liquid contact with at least the first passage, and a plurality of packing elements generated using Additive Manufacturing (AM), where the plurality of packing elements are located in V₂, where at least one of the plurality of packing elements is in material contact with one or more fins of the plurality of fins, where a first gas exits the first working outlet, where a first gas lean gaseous mixture exits the first working port.

Embodiment P2. The GCC device of embodiment P1, where the GCC device is made of an alloy.

Embodiment P3. The GCC device of embodiment P1, where the plurality of packing elements are in material contact with the plurality of fins where a thermal conductivity coefficient between the plurality of packing elements and the plurality of fins is between a lower limit of approximately 1×10¹ Wm⁻¹K⁻¹ and an upper limit of approximately 5×10² Wm⁻¹K⁻¹.

Embodiment P4. The GCC device of embodiment P1, where the first refrigerant inlet is located above the first refrigerant outlet, where the cryogenic refrigerant enters the first volume through the first refrigerant inlet at T₁.

Embodiment P5. The GCC device of embodiment P1, where the plurality of fins are generated using AM such that the at least one of the plurality of fins is in material contact with the first partition wall.

Embodiment P6. The GCC device of embodiment P5, where the plurality of fins are in material contact with the first partition wall where a thermal conductivity coefficient between the at least one of the plurality of fins and the first partition wall is between a lower limit of approximately 1×10¹ Wm⁻¹K⁻¹ and an upper limit of approximately 5×10² Wm⁻¹K⁻¹.

Embodiment P7. The GCC device of embodiment P1, further comprising one or more passages in one or more of the plurality of fins, where at least one of the one or more passages directs gas condensing on a surface of the one or more of the plurality of fins in a direction from the first working port towards the first working outlet.

Embodiment P8. The GCC device of embodiment P1, where the plurality of fins is between a lower limit of approximately 5 and an upper limit of approximately 1×10².

Embodiment P9. The GCC device of embodiment P1, where W is between a lower limit of approximately D×10⁻² and an upper limit of approximately D×10⁻¹.

Embodiment P10. The GCC device of embodiment P1, where W increases from the center increasing towards the partition wall, where W increases from between a lower limit of approximately D×10⁻² and an upper limit of approximately D×10⁻¹.

Embodiment P11. The GCC device of embodiment P1, where the plurality of fins are corrugated.

Embodiment P12. The GCC device of embodiment P11, where W increases from between a lower limit of approximately D×10⁻² and an upper limit of approximately D×10⁻¹.

Embodiment P13. The GCC device of embodiment P11, where an amplitude of a corrugated wave is between a lower limit of approximately D×10⁻³ and an upper limit of approximately D×10⁻².

Embodiment P14. The GCC device of embodiment P11, where a roughness of the plurality of fins is between a lower limit of approximately grade N1 and an upper limit of approximately grade N12.

Embodiment P15. The GCC device of embodiment P1, further comprising a second chamber comprising a third volume and a fourth volume (V₄), where the diameter of the second chamber is D, where a second partition wall at least partially separates the third volume from V₄.

Embodiment P16. The GCC device of embodiment P15, where the second chamber is deployed to the first chamber, where the first chamber is above the second chamber

Embodiment P17. The GCC device of embodiment P16, where the third volume is in fluid contact with a second refrigerant inlet and a second refrigerant outlet, where V₄ comprises a second working port, and a second working outlet, where the GCC device is adapted to connect with the second refrigerant inlet and the second refrigerant outlet to recirculate the cryogenic refrigerant, where the first working outlet is in gas sealable contact with the second working port.

Embodiment P18. The GCC device of embodiment P17, where V₄/V₂ is between a first lower limit of approximately 8×10⁻¹ and a first upper limit of approximately 9×10⁻¹.

Embodiment P19. The GCC device of embodiment P18, where the first refrigerant inlet is located above the first refrigerant outlet, where the second refrigerant inlet is located above the second refrigerant outlet, where the cryogenic refrigerant enters the first volume through the first refrigerant inlet at T₁, where the cryogenic refrigerant enters the third volume through the second refrigerant inlet at a second temperature (T₂).

Embodiment P20. The GCC device of embodiment P19, where T₁=T₂, where V₄/V₂ is between a first lower limit of approximately 8×10⁻¹ and a first upper limit of approximately 9×10⁻¹.

Embodiment P21. The GCC device of embodiment P20, where H is between a second lower limit of approximately 2×D and a second upper limit of approximately 1×10¹×D.

Embodiment P22. The GCC device of embodiment P20, where H is between a second lower limit of approximately 3×D and a second upper limit of approximately 2×10¹×D.

Embodiment P23. The GCC device of embodiment P19, where T₁=T₂, where V₂=V₄.

Embodiment P24. The GCC device of embodiment P23, where H is between a lower limit of approximately 2×D and an upper limit of approximately 1×10¹×D.

Embodiment P25. The GCC device of embodiment P23, where H is between a lower limit of approximately 3×D and an upper limit of approximately 2×10¹×D.

Embodiment P26. The GCC device of embodiment P19, where T₁ is greater than T₂, where the ratio of V₄ to V₂ is between a first lower limit of approximately 8×10⁻¹ and a first upper limit of approximately 9×10⁻¹.

Embodiment P27. The GCC device of embodiment P26, where H is between a second lower limit of approximately 2×D and a second upper limit of approximately 1×10¹×D.

Embodiment P28. The GCC device of embodiment P26, where H is between a second lower limit of approximately 3×D and a second upper limit of approximately 2×10¹×D.

Embodiment P29. The GCC device of embodiment P19, where T₁ is greater than T₂, where V₂ equals V₄.

Embodiment P30. The GCC device of embodiment 29, where H is between a second lower limit of approximately 2×D and a second upper limit of approximately 1×10¹×D.

Embodiment P31. The GCC device of embodiment 29, where H is between a second lower limit of approximately 3×D and a second upper limit of approximately 2×10¹×D.

Embodiment P32. The GCC device of embodiment P19, where T₂>T₁, where V₄/V₂ is between a first lower limit of approximately 8×10⁻¹ and a first upper limit of approximately 9×10⁻¹.

Embodiment P33. The GCC device of embodiment P32, where H is between a second lower limit of approximately 2×D and a second upper limit of approximately 1×10¹×D.

Embodiment P34. The GCC device of embodiment P32, where H is between a second lower limit of approximately 3×D and a second upper limit of approximately 2×10¹×D.

Embodiment P35. The GCC device of embodiment P19, where T₂>T₁, where V₂=V₄.

Embodiment P36. The GCC device of embodiment P29, where H is between a second lower limit of approximately 2×D and a second upper limit of approximately 1×10¹×D.

Embodiment P37. The GCC device of embodiment P35, where H is between a second lower limit of approximately 3×D and a second upper limit of approximately 2×10¹×D.

Embodiment P38. The GCC device of embodiment P19, further comprising a cap that is deployed with a gas sealable contact with the first working port.

Embodiment P39. The GCC device of embodiment P19, further comprising a cup that is deployed with a gas sealable contact with the second working outlet.

Embodiment P40. The GCC device of embodiment P19, further comprising a separator that is deployed between the first chamber and the second chamber.

Embodiment P41. The GCC device of embodiment P40, where the separator is deployed with a gas sealable contact with the first chamber, where the separator is deployed with a gas sealable contact with the second chamber.

Embodiment P42. The GCC device of embodiment P40, where the separator comprises one or more channels.

Embodiment P43. The GCC device of embodiment P42, where the one or more channels are adapted to transport a condensed liquid away from a center point of the GCC device.

Embodiment P44. The GCC device of embodiment P40, where the separator comprises one or more introduction ports.

Embodiment P45. The GCC device of embodiment P40, where the one or more introduction ports are adapted to direct the first gas lean gaseous mixture into the GCC device.

Embodiment P46. The GCC device of embodiment P38, further comprising a valve in the cap and the GCC device of claim 44, where the first gas lean gaseous mixture exiting the valve from the GCC device of embodiment P38 is directed to the one or more introduction ports of the GCC device of claim 44.

Embodiment P47. The GCC device of embodiment P46, where the separator is located between the first chamber and the second chamber.

Embodiment P48. A GCC device for cryogenically separating a first gas from a gaseous mixture comprising a first chamber comprising a diameter (D), a first volume, and a second volume (V₂), where a first partition wall at least partially separates the first volume from V₂, where the first volume is in fluid contact with a first refrigerant inlet and a first refrigerant outlet, where V₂ comprises a first working port, and a first working outlet, where the first chamber is generated using Additive Manufacturing (AM), a plurality of fins located in V₂, where at least one of the plurality of fins is in physical contact with the first partition wall, where at least one of the plurality of fins comprises a first passage, a first passage entrance and a first passage exit, where the first passage connects the first passage entrance to the first passage exit, where the first passage entrance and the first passage exit traverse the first partition wall such that the first passage is in liquid contact with the first volume, where the plurality of fins are generated using AM, a refrigerant supply, where the refrigerant supply is adapted to connect with the first refrigerant inlet and the first refrigerant outlet to allow a cryogenic refrigerant to enter the first volume at a first temperature (T₁), where the refrigerant supply is adapted to flow from the first volume into the first passage entrance and exit the first passage through the first passage exit, where the cryogenic refrigerant is in liquid contact with at least with the first volume, where the cryogenic refrigerant is in liquid contact with at least the first passage, a plurality of packing elements located in V₂, where at least one of the plurality of packing elements is in material contact with one or more fins of the plurality of fins, where the plurality of packing elements are generated using AM, where a first gas exits the first working outlet, where a first gas lean gaseous mixture exits the first working port, a cap that is deployed with a gas sealable contact with the first working port, a cup that is deployed with a gas sealable contact with the second working outlet and one or more introduction ports.

Embodiment P49. The GCC device of embodiment P48, where the plurality of packing elements are in material contact with the plurality of fins where a thermal conductivity coefficient between the plurality of packing elements and the plurality of fins is between a lower limit of approximately 1×10¹ Wm⁻¹K⁻¹ and an upper limit of approximately 5×10² Wm⁻¹K⁻¹.

Embodiment P50. The GCC device of embodiment P48, where at least one of the plurality of fins is in material contact with the first partition wall.

Embodiment P51. The GCC device of embodiment P50, where the plurality of fins are in material contact with the first partition wall where a thermal conductivity coefficient between the at least one of the plurality of fins and the first partition wall is between a lower limit of approximately 1×10¹ Wm⁻¹K⁻¹ and an upper limit of approximately 5×10² Wm⁻¹K⁻¹.

Embodiment P52. The GCC device of embodiment P48, further comprising a second chamber comprising a third volume and a fourth volume (V₄), where a diameter of the second chamber equals D.

Embodiment P53. The GCC device of embodiment P50, where the second chamber is deployed to the first chamber.

Embodiment P54. The GCC device of embodiment P53, where a second partition wall at least partially separates the third volume from V₄.

Embodiment P55. The GCC device of embodiment P54, where the third volume is in fluid contact with a second refrigerant inlet and a second refrigerant outlet, where V₄ comprises a second working port, and a second working outlet, where the refrigerant supply is adapted to connect with the second refrigerant inlet and the second refrigerant outlet to recirculate the cryogenic refrigerant, where the first working outlet is in gas sealable contact with the second refrigerant inlet, where V₂ equals V₄.

Embodiment P56. The GCC device of embodiment P55, where H is between a lower limit of approximately 2×D and an upper limit of approximately 1×10¹×D.

Embodiment P57. The GCC device of embodiment P55, where H is between a lower limit of approximately 3×D and an upper limit of approximately 2×10¹×D.

Embodiment P58. The GCC device of embodiment P48 where the third volume is in fluid contact with a second refrigerant inlet and a second refrigerant outlet, where V₄ comprises a second working port, and a second working outlet, where the refrigerant supply is adapted to connect with the second refrigerant inlet and the second refrigerant outlet to recirculate the cryogenic refrigerant, where the first working outlet is in gas sealable contact with the second refrigerant inlet, where the second chamber is positioned below the first chamber, where V₄/V₂ is between a first lower limit of approximately 8×10⁻¹ and a first upper limit of approximately 9×10⁻¹.

Embodiment P59. The GCC device of embodiment P58, where H is between: a second lower limit of approximately 2×D and a second upper limit of approximately 1×10¹×D.

Embodiment P60. The GCC device of embodiment P58, where H is between a second lower limit of approximately 3×D and a second upper limit of approximately 2×10¹×D.

Embodiment P61. A method of cryogenically separating a first gas from a gaseous mixture including introducing a working gas into a first GCC device, where the first GCC device is as disclosed in c embodiment P17 and directing the outflow of the second working outlet of the first GCC device into a second GCC device.

Embodiment P62. A method of manufacturing a GCC device including producing at least the first partition wall, the second partition wall, the plurality of fins and the plurality of packing elements of the GCC device as set forth in embodiment P38 using Additive Manufacturing (AM), where at least the first partition wall, the second partition wall, the plurality of fins and the plurality of packing elements comprise the alloy as set forth in embodiment P2 manufactured with AM.

Embodiment P63. A GCC device for cryogenically separating a first gas from a gaseous mixture including a first chamber comprising a diameter (D), a first volume, and a second volume, where a first partition wall at least partially separates the first volume from the second volume, where a dimension of the first chamber has a surface area to volume ratio (SaV), where the first volume is in fluid contact with a first refrigerant inlet and a first refrigerant outlet, where the second volume comprises a first working port, and a first working outlet, a refrigerant supply, where the refrigerant supply is adapted to connect with the first refrigerant inlet and the first refrigerant outlet to allow recirculated supply of a cryogenic refrigerant, where the cryogenic refrigerant from the refrigerant supply is in liquid contact at least with the first volume, a plurality of fins generated using Additive Manufacturing (AM), where the plurality of fins are located in the second volume, where at least one of the plurality of fins is in contact with the first partition wall, where at least one of the plurality of fins is in liquid contact with the first volume; a plurality of packing elements located in the second volume, where at least one of the plurality of packing elements is in contact with one or more fins of the plurality of fins, where a first gas exits the first working outlet, where a first gas lean gaseous mixture exits the first working port; a cap that is deployed with a gas sealable contact with the first working port, a cup that is deployed with a gas sealable contact with the first working outlet and one or more introduction ports.

Embodiment Q1. A GCC device for liquefying a stream of gaseous carbon dioxide molecules including (a) a first chamber comprising an introduction port, a working port, a working outlet, a plurality of packing elements, a first volume (V₁), and a second volume (V₂), where a first partition wall at least partially separates V₁ from V₂, where the first partition wall comprises an inside wall and an outside wall, where the inside wall is in contact with V₁, where the outside wall is in contact with V₂, where V₁ is in fluid contact with a first refrigerant inlet and a first refrigerant outlet, where the working port, the working outlet, and the plurality of packing elements are located in V₂, (b) a plurality of fins located in V₂, where at least one of the plurality of fins is in physical contact with the outside wall, where at least one of the plurality of fins comprises a passage, a passage entrance and a passage exit, where the first partition wall extends to the passage, where the passage connects Vito the passage entrance, where the passage connects the passage exit to V₁, where at least one of the plurality of packing elements is in physical contact with one or both one or more fins of the plurality of fins and the outside wall, and (c) a refrigerant supply adapted to supply a refrigerant through the first refrigerant inlet into V₁, where the refrigerant is in physical contact with the inside wall, where the refrigerant exits through the first refrigerant outlet, where the refrigerant supply is also adapted to supply the refrigerant through the passage entrance from V₁, where the refrigerant exits the passage through the passage exit into V₁, where in the absence of the refrigerant the outside wall is at a first temperature, where the refrigerant flowing through V₁ reduces the first temperature of the outside wall, where the GCC device is adapted to direct the stream of gaseous carbon dioxide molecules into V₂, where the one or more of the plurality of gaseous carbon dioxide molecules condense on one or more of the outside wall, the plurality of fins and the plurality of packing elements, where liquefied carbon dioxide molecules collect at the bottom of the GCC device, where the GCC device is adapted to direct a stream of gas lean gaseous mixture to the working outlet.

Embodiment Q2. The GCC device of Embodiment Q1, where the GCC device is made of an alloy.

Embodiment Q3. The GCC device of Embodiment Q1, where the plurality of packing elements are generated using AM.

Embodiment Q4. The GCC device of Embodiment Q3, where the plurality of packing elements are located throughout V₂.

Embodiment Q5. The GCC device of Embodiment Q4, where one or more of the plurality of fins are in physical contact with one or both the outside wall and the plurality of packing elements.

Embodiment Q6. The GCC device of Embodiment Q5, where a thermal conductivity coefficient between the one or more of the plurality of fins and one or both the outside wall and the plurality of packing elements is between a lower limit of approximately 1×10¹ Wm⁻¹K⁻¹, and an upper limit of approximately 5×10² Wm⁻¹K⁻¹. In this range approximately means plus or minus ten percent.

Embodiment Q7. The GCC device of Embodiment Q1, where the passage directs the stream of gaseous carbon dioxide molecules in a direction from the working port towards the working outlet.

Embodiment Q8. The GCC device of Embodiment Q1, where the plurality of fins is between a lower limit of approximately 5, and an upper limit of approximately 2×10¹. In this range approximately means plus or minus one significant figure.

Embodiment Q9. The GCC device of Embodiment Q1, where one or more of the plurality of fins are generated with a corrugated wave.

Embodiment Q10. The GCC device of Embodiment Q1, where a roughness of one or more of the plurality of fins is between a lower limit of approximately grade N1, and an upper limit of approximately grade N12. In this range approximately means plus or minus ten percent.

Embodiment Q11. A method of using a GCC device to liquefy a stream of gas containing a plurality of gaseous carbon dioxide molecules including introducing the stream of gas into the GCC device, where the GCC device includes (a) a first chamber comprising a working outlet, a plurality of packing elements, a first volume (V₁), and a second volume (V₂), where a first partition wall at least partially separates V₁ from V₂, where the first partition wall comprises an inside wall and an outside wall, where the inside wall is in contact with V₁, where the outside wall is in contact with V₂, where V₁ is in fluid contact with a first refrigerant inlet and a first refrigerant outlet, where the working outlet, and the plurality of packing elements are located in V₂, (b) a plurality of fins located in V₂, where at least one of the plurality of fins is in physical contact with the outside wall, where at least one of the plurality of fins comprises a passage, a passage entrance and a passage exit, where the first partition wall extends to the passage, where the passage connects V₁ to the passage entrance, where the passage connects the passage exit to V₁, where at least one of the plurality of packing elements is in physical contact with one or both one or more fins of the plurality of fins and the outside wall, and (c) a refrigerant supply adapted to supply a refrigerant through the first refrigerant inlet into V₁, where the refrigerant is in physical contact with the inside wall, where the refrigerant exits through the first refrigerant outlet, where the refrigerant supply is also adapted to supply the refrigerant through the passage entrance from V₁, where the refrigerant exits the passage through the passage exit into V₁, where in the absence of the refrigerant the outside wall is at a first temperature, where the refrigerant reduces the first temperature of the outside wall, and directing the stream of gas into V₂, condensing one or more of the plurality of gaseous carbon dioxide molecules on one or both the one or more fins of the plurality of fins and the outside wall; and directing a stream of a gas lean gaseous mixture to the working outlet, and collecting one or more liquefied carbon dioxide molecules in the GCC device.

Embodiment Q12. The method of Embodiment Q11, where the gas lean gaseous mixture comprise one or more gaseous impurities.

Embodiment Q13. The method of Embodiment Q12, where the one or more gaseous impurities exit the GCC device.

Embodiment Q14. A method of using a GCC device to liquefy a stream of gas containing a plurality of gaseous carbon dioxide molecules including introducing the stream of gas into the GCC device, where the GCC device includes (a) a first chamber comprising an introduction port, a working outlet, a working port, a plurality of packing elements, a first volume (V₁), and a second volume (V₂), where a first partition wall at least partially separates V₁ from V₂, where the first partition wall comprises an inside wall and an outside wall, where the inside wall is in contact with V₁, where the outside wall is in contact with V₂, where V₁ is in fluid contact with a first refrigerant inlet and a first refrigerant outlet, where the working outlet, and the plurality of packing elements are located in V₂, (b) a plurality of fins located in V₂, where at least one of the plurality of fins is in physical contact with the outside wall, where at least one of the plurality of fins comprises a passage, a passage entrance and a passage exit, where the first partition wall extends to the passage, where the passage connects V₁ to the passage entrance, where the passage connects the passage exit to V₁, where at least one of the plurality of packing elements is in physical contact with one or both one or more fins of the plurality of fins and the outside wall, and (c) a refrigerant supply adapted to supply a refrigerant through the first refrigerant inlet into V₁, where the refrigerant is in physical contact with the inside wall, where the refrigerant exits through the first refrigerant outlet, where the refrigerant supply is also adapted to supply the refrigerant through the passage entrance from V₁, where the refrigerant exits the passage through the passage exit into V₁, where in the absence of the refrigerant the outside wall is at a first temperature, where the refrigerant reduces the first temperature of the outside wall, and directing the stream of gas through the introduction port into V₂, condensing one or more of the plurality of gaseous carbon dioxide molecules on one or both the one or more fins of the plurality of fins and the outside wall, directing a stream of a gas lean gaseous mixture to the working outlet, and collecting one or more liquefied carbon dioxide molecules exiting the GCC device through the working outlet.

Embodiment Q15. The method of Embodiment Q14, where the gas lean gaseous mixture comprises one or more gaseous impurities.

Embodiment Q16. The method of Embodiment Q15, where the one or more gaseous impurities exit the GCC device through the working port.

Embodiment Q17. A Hybrid GCC device for liquefying a stream of gaseous carbon dioxide molecules including (a) a first chamber comprising a first introduction port, a first working port, a first working outlet, a plurality of packing elements, a first volume (V₁), and a second volume (V₂), where a first partition wall at least partially separates V₁ from V₂, where the first partition wall comprises an inside wall and an outside wall, where the inside wall is in contact with V₁, where the outside wall is in contact with V₂, where V₁ is in fluid contact with a first refrigerant inlet and a first refrigerant outlet, where the first introduction port, the first working port, the first working outlet, and the plurality of packing elements are located in V₂, (b) a second chamber comprising a second introduction port, a second working port, a second working outlet, where the second chamber is a distillation column, where the second chamber does not comprise a packing element, where the first chamber is adapted to be fluidly connected to the second chamber, where the second working port is adapted to be fluidly connected to the first introduction port, (c) a plurality of fins located in V₂, where at least one of the plurality of fins is in physical contact with the outside wall, where at least one of the plurality of fins comprises a passage, a passage entrance and a passage exit, where the first partition wall extends to the passage, where the passage connects V₁ to the passage entrance, where the passage connects the passage exit to V₁, where at least one of the plurality of packing elements is in physical contact with one or both one or more fins of the plurality of fins and the outside wall, and (d) a refrigerant supply adapted to supply a refrigerant through the first refrigerant inlet into V₁, where the refrigerant is in physical contact with the inside wall, where the refrigerant exits through the first refrigerant outlet, where the refrigerant supply is also adapted to supply the refrigerant through the passage entrance from V₁, where the refrigerant exits the passage through the passage exit into V₁, where in the absence of the refrigerant the outside wall is at a first temperature, where the refrigerant reduces the first temperature of the outside wall, where the GCC device is adapted to direct the stream of gaseous carbon dioxide molecules into V₂, where the one or more of the plurality of gaseous carbon dioxide molecules condense on one or more of the outside wall, the plurality of fins and the plurality of packing elements, where liquefied carbon dioxide molecules collect at the bottom of the GCC device, where the GCC device is adapted to direct a stream of gas lean gaseous mixture to the first working outlet.

Embodiment Q18. The Hybrid GCC device of Embodiment Q17, where the GCC device is made of an alloy.

Embodiment Q19. The Hybrid GCC device of Embodiment Q17, where the plurality of packing elements are generated using AM.

Embodiment Q20. The Hybrid GCC device of Embodiment Q19, where the plurality of packing elements are located throughout V₂.

Embodiment Q21. The Hybrid GCC device of Embodiment Q20, where one or more of the plurality of fins are in physical contact with one or both the outside wall and the plurality of packing elements.

Embodiment Q22. The Hybrid GCC device of Embodiment Q21, where a thermal conductivity coefficient between the one or more of the plurality of fins and one or both the outside wall and the plurality of packing elements is between a lower limit of approximately 1×10¹ Wm⁻¹K⁻¹, and an upper limit of approximately 5×10² Wm⁻¹K⁻¹. In this range approximately means plus or minus ten percent.

Embodiment Q23. The GCC device of Embodiment Q17, where the passage directs the stream of gaseous carbon dioxide molecules in a direction from the first working port towards the first working outlet.

Embodiment Q24. The GCC device of Embodiment Q17, where the plurality of fins is between a lower limit of approximately 5, and an upper limit of approximately 2×10¹. In this range approximately means plus or minus one significant figure.

Embodiment Q25. The Hybrid GCC device of Embodiment Q17, where one or more of the plurality of fins are generated with a corrugated wave.

Embodiment Q26. The Hybrid GCC device of Embodiment Q17, where a roughness of one or more of the plurality of fins is between a lower limit of approximately grade N1, and an upper limit of approximately grade N12. In this range approximately means plus or minus ten percent.

Embodiment Q27. A GCC system for liquefying a stream of gaseous carbon dioxide molecules including (a) a first chamber comprising a first introduction port, a first working port, a first working outlet, a first plurality of packing elements, a first volume (V₁), and a second volume (V₂), where a first partition wall at least partially separates V₁ from V₂, where the first partition wall comprises a first inside wall and a first outside wall, where the first inside wall is in contact with V₁, where the first outside wall is in contact with V₂, where V₁ is in fluid contact with a first refrigerant inlet and a first refrigerant outlet, where the first introduction port, the first working port, the first working outlet, and the first plurality of packing elements are located in V₂, (b) a second chamber comprising a second introduction port, a second working port, a second working outlet, a second plurality of packing elements, a third volume (V₃), and a fourth volume (V₄), where a second partition wall at least partially separates V₃ from V₄, where the second partition wall comprises a second inside wall and a second outside wall, where the second inside wall is in contact with V₃, where the second outside wall is in contact with V₄, where V₃ is in fluid contact with a second refrigerant inlet and a second refrigerant outlet, where the second introduction port, the second working port, the second working outlet, and the second plurality of packing elements are located in V₄, where the first chamber is adapted to be fluidly connected to the second chamber, where the first working outlet is adapted to be fluidly connected to the second introduction port, (c) a first plurality of fins located in V₂, where at least one of the first plurality of fins is in physical contact with the first outside wall, where at least one of the first plurality of fins comprises a first passage, a first passage entrance and a first passage exit, where the first passage connects the first passage entrance to the first passage exit, where the first partition wall extends to the first passage, where the first passage connects V₁ to the first passage entrance, where the first passage connects the first passage exit to V₁, where at least one of the first plurality of packing elements is in physical contact with one or both one or more first fins of the first plurality of fins and the first outside wall, (c) a second plurality of fins located in V₄, where at least one of the second plurality of fins is in physical contact with the second outside wall, where at least one of the second plurality of fins comprises a second passage, a second passage entrance and a second passage exit, where the second passage connects the second passage entrance to the second passage exit, where the second passage connects the second passage entrance to the second passage exit, where the second partition wall extends to the second passage, where the second passage connects V₁ to the second passage entrance, where the second passage connects the second passage exit to V₁, where at least one of the second plurality of packing elements is in physical contact with one or both one or more second fins of the second plurality of fins and the second outside wall, and (d) a refrigerant supply adapted to supply a refrigerant through the first refrigerant inlet into V₁, where the refrigerant is in physical contact with the first inside wall, where the refrigerant exits through the first refrigerant outlet, where the refrigerant supply is also adapted to supply the refrigerant through the first passage entrance from V₁, where the refrigerant exits the first passage through the first passage exit into V₁, where in the absence of the refrigerant the first outside wall is at a first temperature, where the refrigerant reduces the first temperature of the first outside wall, where the GCC device is adapted to direct the stream of gaseous carbon dioxide molecules into V₂, where the one or more of the plurality of gaseous carbon dioxide molecules condense on one or more of the first outside wall, the first plurality of fins and the first plurality of packing elements, where liquefied carbon dioxide molecules collect at the first working port, where the GCC device is adapted to direct a stream of gas lean gaseous mixture to the first working outlet, where the refrigerant supply is adapted to supply the refrigerant through the second passage entrance into V₃, where the refrigerant is in physical contact with the second inside wall and exits through the second passage exit, where in the absence of the refrigerant the second outside wall is at a second temperature, where the refrigerant reduces the second temperature of the second outside wall, where the GCC device is adapted to direct the stream of gaseous carbon dioxide molecules into V₄, where the one or more of the plurality of gaseous carbon dioxide molecules condense one or more of the second outside wall, the second plurality of fins and the second plurality of packing elements, where liquefied carbon dioxide molecules collect at the second working port, where the GCC device is adapted to direct a stream of gas lean gaseous mixture to exit at the second working outlet.

Embodiment Q28. The GCC device of Embodiment Q27, where the GCC device is made of an alloy.

Embodiment Q29. The GCC device of Embodiment Q27, where the first plurality of packing elements are generated using AM.

Embodiment Q30. The GCC device of Embodiment Q29, where the first plurality of packing elements are located throughout V₂.

Embodiment Q31. The GCC device of Embodiment Q30, where one or more of the first plurality of fins are in physical contact with one or both the first outside wall and the first plurality of packing elements.

Embodiment Q32. The GCC device of Embodiment Q31, where a thermal conductivity coefficient between the one or more of the first plurality of fins and one or both the first outside wall and the first plurality of packing elements is between a lower limit of approximately 1×10¹ Wm⁻¹K⁻¹, and an upper limit of approximately 5×10² Wm⁻¹K⁻¹. In this range approximately means plus or minus ten percent.

Embodiment Q33. The GCC device of Embodiment Q27, where the first passage directs the stream of gaseous carbon dioxide molecules in a direction from the first working port towards the first working outlet.

Embodiment Q34. The GCC device of Embodiment Q27, where the first plurality of fins is between a lower limit of approximately 5, and an upper limit of approximately 2×10¹. In this range approximately means plus or minus one significant figure.

Embodiment Q35. The GCC device of Embodiment Q27, where one or more of the first plurality of fins are generated with a corrugated wave.

Embodiment Q36. The GCC device of Embodiment Q27, where a roughness of one or more of the first plurality of fins is between a lower limit of approximately grade N1, and an upper limit of approximately grade N12. In this range approximately means plus or minus ten percent.

Embodiment Q37. A GCC device for liquefying a stream of gaseous carbon dioxide molecules including (a) a first chamber comprising an introduction port, a working port, a working outlet, a first volume (V₁), and a second volume (V₂), where a first partition wall at least partially separates V₁ from V₂, where the first partition wall comprises an inside wall and an outside wall, where the inside wall is in contact with V₁, where the outside wall is in contact with V₂, where V₁ is in fluid contact with a first refrigerant inlet and a first refrigerant outlet, where the working port, and the working outlet are located in V₂, (b) a plurality of fins located in V₂, where at least one of the plurality of fins is in physical contact with the outside wall, where at least one of the plurality of fins comprises a passage, a passage entrance and a passage exit, where the first partition wall extends to the passage, where the passage connects V₁ to the passage entrance, where the passage connects the passage exit to V₁, where the passage connects the passage entrance to the passage exit, and (c) a refrigerant supply adapted to supply a refrigerant through the first refrigerant inlet into V₁, where the refrigerant is in physical contact with the inside wall, where the refrigerant exits through the first refrigerant outlet, where the refrigerant supply is also adapted to supply the refrigerant through the passage entrance from V₁, where the refrigerant exits the passage through the passage exit into V₁, where in the absence of the refrigerant the outside wall is at a first temperature, where the refrigerant reduces the first temperature of the outside wall, where the GCC device is adapted to direct the stream of gaseous carbon dioxide molecules into V₂, where the one or more of the plurality of gaseous carbon dioxide molecules condense on one or more of the outside wall, the plurality of fins and the plurality of packing elements, where liquefied carbon dioxide molecules collect at the bottom of the GCC device, where the GCC device is adapted to direct a stream of gas lean gaseous mixture to the working outlet.

Embodiment Q38. The GCC device of Embodiment Q37, where the GCC device is made of an alloy.

Embodiment Q39. The GCC device of Embodiment Q37, where one or more of the plurality of fins are in physical contact with the outside wall.

Embodiment Q40. The GCC device of Embodiment Q37, where a thermal conductivity coefficient between the one or more of the plurality of fins and the outside wall is between a lower limit of approximately 1×10¹ Wm⁻¹K⁻¹, and an upper limit of approximately 5×10² Wm⁻¹K⁻¹. In this range approximately means plus or minus ten percent.

Embodiment Q41. The GCC device of Embodiment Q37, where the passage directs the stream of gaseous carbon dioxide molecules in a direction from the working port towards the working outlet.

Embodiment Q42. The GCC device of Embodiment Q37, where the plurality of fins is between a lower limit of approximately 5, and an upper limit of approximately 2×10¹. In this range approximately means plus or minus one significant figure.

Embodiment Q43. The GCC device of Embodiment Q37, where one or more of the plurality of fins are generated with a corrugated wave.

Embodiment Q44. The GCC device of Embodiment Q37, where a roughness of one or more of the plurality of fins is between a lower limit of approximately grade N1, and an upper limit of approximately grade N12. In this range approximately means plus or minus ten percent.

Embodiment Q45. A GCC device for liquefying a stream of gaseous carbon dioxide molecules including (a) a first chamber comprising an introduction port, a working port, a working outlet, a plurality of packing elements, a first volume (V₁), and a second volume (V₂), where a first partition wall at least partially separates V₁ from V₂, where the first partition wall comprises an inside wall and an outside wall, where the inside wall is in contact with V₁, where the outside wall is in contact with V₂, where V₁ is in fluid contact with a first refrigerant inlet and a first refrigerant outlet, where the working port, the working outlet, and the plurality of packing elements are located in V₂, where at least one of the plurality of packing elements is in physical contact with the outside wall, and (b) a refrigerant supply adapted to supply a refrigerant through the first refrigerant inlet into V₁, where the refrigerant is in physical contact with the inside wall, where the refrigerant exits through the first refrigerant outlet, where in the absence of the refrigerant the outside wall is at a first temperature, where the refrigerant reduces the first temperature of the outside wall, where the GCC device is adapted to direct the stream of gaseous carbon dioxide molecules into V₂, where the one or more of the plurality of gaseous carbon dioxide molecules condense on one or more of the outside wall, the plurality of fins and the plurality of packing elements, where liquefied carbon dioxide molecules collect at the bottom of the GCC device, where the GCC device is adapted to direct a stream of gas lean gaseous mixture to the working outlet.

Embodiment Q46. The GCC device of Embodiment Q45, where the GCC device is made of an alloy.

Embodiment Q47. The GCC device of Embodiment Q45, where the plurality of packing elements are generated using A.

Embodiment Q48. The GCC device of Embodiment Q45, where the plurality of packing elements are located throughout V₂.

Embodiment Q49. The GCC device of Embodiment Q45, where a thermal conductivity coefficient between the outside wall and the plurality of packing elements is between a lower limit of approximately 1×10¹ Wm⁻¹K⁻¹, and an upper limit of approximately 5×10² Wm⁻¹K⁻¹. In this range approximately means plus or minus ten percent.

While the systems, methods, and devices have been illustrated by describing examples, it is not the intention of the applicants to restrict or in any way limit the scope of the appended claims to such detail. It is, of course, not possible to describe every conceivable combination of components or methodologies for purposes of describing the systems, methods, and devices provided herein. Additional advantages and modifications will readily be apparent to those skilled in the art. Therefore, the invention, in its broader aspects, is not limited to the specific details, the representative system and method or device shown and described. Accordingly, departures may be made from such details without departing from the spirit or scope of the applicant's general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

TABLE 1
Comparison between Distillation Column configuration
361 shown in FIG. 12A and Distillation Column
configuration 359 shown in FIG. 12B.

| | Configuration 361 | | Configuration 359 | |
|---|---|---|---|---|
| | (FIG. 12A) | | (FIG. 12B) | |
| Time from level sensor to level | 180 | minutes | 40 | minutes |
| transmitter | | | | |
| Level rate of increase in Column | 6.1 inches/hr | | 11.7 inches/hr | |
| | (154.94 mm/hr) | | (297.18 mm/hr) | |
| Liquid CO₂ production rate | 1.38 | kg/hr | 2.64 | kg/hr |
| O₂ ppm in liquid CO₂ | 4200 | ppm | 4000 | ppm |

What is claimed is:

1. A GCC (Gas Condensing Column) device for liquefying a stream of gaseous carbon dioxide molecules comprising:
(a) a first chamber comprising an introduction port, a working port, a working outlet, a plurality of packing elements, a first volume (V₁), and a second volume (V₂), where a first partition wall at least partially separates V₁ from V₂, where the first partition wall comprises an inside wall and an outside wall, where the inside wall is in contact with V₁, where the outside wall is in contact with V₂, where V₁ is in fluid contact with a first refrigerant inlet and a first refrigerant outlet, where the working port, the working outlet, and the plurality of packing elements are located in V₂;
(b) a plurality of fins located in V₂, where at least one of the plurality of fins is in physical contact with the outside wall, where at least one of the plurality of fins comprises a passage, a passage entrance and a passage exit, where the first partition wall extends to the passage, where the passage connects V₁ to the passage entrance, where the passage connects the passage exit to V₁, where at least one of the plurality of packing elements is in physical contact with one or both one or more fins of the plurality of fins and the outside wall; and
(c) a refrigerant supply adapted to supply a refrigerant through the first refrigerant inlet into V₁, where the refrigerant is in physical contact with the inside wall, where the refrigerant exits through the first refrigerant outlet, where the refrigerant supply is also adapted to supply the refrigerant through the passage entrance from V₁, where the refrigerant exits the passage through the passage exit into V₁, where in the absence of the refrigerant the outside wall is at a first temperature, where the refrigerant flowing through V₁ reduces the first temperature of the outside wall, where the GCC device is adapted to direct the stream of gaseous carbon dioxide molecules into V₂, where the one or more of the plurality of gaseous carbon dioxide molecules condense on one or more of the outside wall, the plurality of fins and the plurality of packing elements, where liquefied carbon dioxide molecules collect at the bottom of the GCC device, where the GCC device is adapted to direct a stream of gas lean gaseous mixture to the working outlet.

2. The GCC device of claim 1, where the GCC device is made of an alloy.

3. The GCC device of claim 1, where the plurality of packing elements are generated using Additive Manufacturing.

4. The GCC device of claim 3, where the plurality of packing elements are located throughout V₂.

5. The GCC device of claim 4, where one or more of the plurality of fins are in physical contact with one or both the outside wall and the plurality of packing elements.

6. The GCC device of claim 5, where a thermal conductivity coefficient between the one or more of the plurality of fins and one or both the outside wall and the plurality of packing elements is between:
a lower limit of approximately 1×10¹ Wm⁻¹K⁻¹; and
an upper limit of approximately 5×10² Wm⁻¹K⁻¹.

7. The GCC device of claim 1, where the passage directs the stream of gaseous carbon dioxide molecules in a direction from the working port towards the working outlet.

8. The GCC device of claim 1, where the plurality of fins is between:
a lower limit of approximately 5; and
an upper limit of approximately 2×10¹.

9. The GCC device of claim 1, where one or more of the plurality of fins are generated with a corrugated wave.

10. The GCC device of claim 1, where a roughness of one or more of the plurality of fins is between:
a lower limit of approximately grade N1; and
an upper limit of approximately grade N12.

11. A method of using a GCC (Gas Condensing Column) device to liquefy a stream of gas containing a plurality of gaseous carbon dioxide molecules comprising:
introducing the stream of gas into the GCC device, where the GCC device comprises:
(a) a first chamber comprising an introduction port, a working outlet, a working port, a plurality of packing elements, a first volume (V₁), and a second volume (V₂), where a first partition wall at least partially separates V₁ from V₂, where the first partition wall comprises an inside wall and an outside wall, where the inside wall is in contact with V₁, where the outside wall is in contact with V₂, where V₁ is in fluid contact with a first refrigerant inlet and a first refrigerant outlet, where the working outlet, and the plurality of packing elements are located in V₂;
(b) a plurality of fins located in V₂, where at least one of the plurality of fins is in physical contact with the outside wall, where at least one of the plurality of fins comprises a passage, a passage entrance and a passage exit, where the first partition wall extends to the passage, where the passage connects V₁ to the passage entrance, where the passage connects the passage exit to V₁, where at least one of the plurality of packing elements is in physical contact with one or both one or more fins of the plurality of fins and the outside wall; and
(c) a refrigerant supply adapted to supply a refrigerant through the first refrigerant inlet into V₁, where the refrigerant is in physical contact with the inside wall, where the refrigerant exits through the first refrigerant outlet, where the refrigerant supply is also adapted to supply the refrigerant through the passage entrance from V₁, where the refrigerant exits the passage through the passage exit into V₁, where in the absence of the refrigerant the outside wall is at a first temperature, where the refrigerant reduces the first temperature of the outside wall; and
directing the stream of gas through the introduction port into V₂;
condensing one or more of the plurality of gaseous carbon dioxide molecules on one or both the one or more fins of the plurality of fins and the outside wall;
directing a stream of a gas lean gaseous mixture to the working outlet; and
collecting one or more liquefied carbon dioxide molecules exiting the GCC device through the working outlet.

12. The method of claim 11, where the gas lean gaseous mixture comprises one or more gaseous impurities.

13. The method of claim 12, where the one or more gaseous impurities exit the GCC device through the working port.

14. A Hybrid GCC (Gas Condensing Column) device for liquefying a stream of gaseous carbon dioxide molecules comprising:
(a) a first chamber comprising a first introduction port, a first working port, a first working outlet, a plurality of packing elements, a first volume (V₁), and a second volume (V₂), where a first partition wall at least partially separates V₁ from V₂, where the first partition wall comprises an inside wall and an outside wall, where the inside wall is in contact with V₁, where the outside wall is in contact with V₂, where V₁ is in fluid contact with a first refrigerant inlet and a first refrigerant outlet, where the first introduction port, the first working port, the first working outlet, and the plurality of packing elements are located in V₂;
(b) a second chamber comprising a second introduction port, a second working port, a second working outlet, where the second chamber is a distillation column, where the second chamber does not comprise a packing element, where the first chamber is adapted to be fluidly connected to the second chamber, where the second working port is adapted to be fluidly connected to the first introduction port;
(c) a plurality of fins located in V₂, where at least one of the plurality of fins is in physical contact with the outside wall, where at least one of the plurality of fins comprises a passage, a passage entrance and a passage exit, where the first partition wall extends to the passage, where the passage connects V₁ to the passage entrance, where the passage connects the passage exit to V₁, where at least one of the plurality of packing elements is in physical contact with one or both one or more fins of the plurality of fins and the outside wall; and
(d) a refrigerant supply adapted to supply a refrigerant through the first refrigerant inlet into V₁, where the refrigerant is in physical contact with the inside wall, where the refrigerant exits through the first refrigerant outlet, where the refrigerant supply is also adapted to supply the refrigerant through the passage entrance from V₁, where the refrigerant exits the passage through the passage exit into V₁, where in the absence of the refrigerant the outside wall is at a first temperature, where the refrigerant reduces the first temperature of the outside wall, where the GCC device is adapted to direct the stream of gaseous carbon dioxide molecules into V₂, where the one or more of the plurality of gaseous carbon dioxide molecules condense on one or more of the outside wall, the plurality of fins and the plurality of packing elements, where liquefied carbon dioxide molecules collect at the bottom of the GCC device, where the GCC device is adapted to direct a stream of gas lean gaseous mixture to the first working outlet.

15. The Hybrid GCC device of claim 14, where the GCC device is made of an alloy.

16. The Hybrid GCC device of claim 14, where the plurality of packing elements are generated using Additive Manufacturing.

17. The Hybrid GCC device of claim 16, where the plurality of packing elements are located throughout V₂.

18. The Hybrid GCC device of claim 17, where one or more of the plurality of fins are in physical contact with one or both the outside wall and the plurality of packing elements.

19. The Hybrid GCC device of claim 18, where a thermal conductivity coefficient between the one or more of the plurality of fins and one or both the outside wall and the plurality of packing elements is between:
a lower limit of approximately 1×10¹ Wm⁻¹K⁻¹; and
an upper limit of approximately 5×10² Wm⁻¹K⁻¹.

20. The Hybrid GCC device of claim 14, where one or more of the plurality of fins are generated with a corrugated wave.
